(19) United States
(12) Patent Application Publication
(10) Pub. No.: US 2025/0301117 A1
(43) Pub. Date: Sep. 25, 2025

(54) ELECTRONIC DEVICE AND METHOD FOR GENERATING VISUAL OBJECT CORRESPONDING TO MOTION OF EXTERNAL OBJECT

(71) Applicant: SAMSUNG ELECTRONICS CO., LTD., Suwon-si (KR)

(72) Inventors: Jingun JUNG, Suwon-si (KR); Jiyeon MA, Suwon-si (KR); Kihyoung SON, Suwon-si (KR); Youngah LEE, Suwon-si (KR); Sungjun HWANG, Suwon-si (KR)

(73) Assignee: SAMSUNG ELECTRONICS CO., LTD, Suwon-si (KR)

(21) Appl. No.: 19/229,527

(22) Filed: Jun. 5, 2025

Related U.S. Application Data
(63) Continuation of application No. PCT/KR2023/015891, filed on Oct. 14, 2023.

(30) Foreign Application Priority Data
Dec. 5, 2022 (KR) 10-2022-0167619

(51) Int. Cl. H04N 13/279; G06F 3/04815; H04N 13/363

(52) U.S. Cl. CPC H04N 13/279; G06F 3/04815; H04N 13/363

(57) ABSTRACT

A method for an electronic device comprising a first projection assembly, includes: identifying an external electronic device including a second projection assembly; based on identifying the external electronic device, transmitting to the external electronic device, a first signal for displaying a screen based on a combination of a first display area and a second display area; based on identifying an external object that is spaced less than a specified distance from the first display area and the second display area, transmitting, to the external electronic device, a second signal increasing a size of an overlapping area in which the first display area and the second display area overlap; and based on identifying motion of the external object related to the overlapping area with the increased size increased based on the second signal, displaying a visual object with a shape related to the motion within the first display area.

### CROSS-REFERENCE TO RELATED APPLICATIONS

This application is a by-pass continuation application of International Application No. PCT/KR2023/015891, filed on Oct. 14, 2023, which is based on and claims priority to Korean Patent Application No. 10-2022-0167619, filed on Dec. 5, 2022, in the Korean Intellectual Property Office, the disclosures of which are incorporated by reference herein their entireties.

### BACKGROUND

### 1. Field

The present disclosure relates to an electronic device and a method for generating a visual object corresponding to a motion of an external object.

### 2. Description of Related Art

An electronic device for visualizing information has been developed. The electronic device may include a television, a monitor, an electric display board, a beam projector, a mobile phone, and/or a tablet personal computer (PC). The electronic device may form a displaying area representing the information on a surface of the electronic device or a surface of the outside of the electronic device.

### SUMMARY

According to an aspect of the disclosure, an electronic device includes: communication circuitry; a camera; a first projection assembly; at least one processor comprising processing circuitry, the at least one processor being operatively connected with the communication circuitry, the camera, and the first projection assembly; and memory comprising one or more storage mediums storing instructions, wherein the instructions, when executed by the at least one processor individually or collectively, cause the electronic device to: identify, via the communication circuitry, an external electronic device including a second projection assembly distinct from the first projection assembly, based on identifying the external electronic device, transmit, to the external electronic device, a first signal for displaying a screen based on a combination of a first display area formed by the first projection assembly and a second display area formed by the second projection assembly, based on identifying, using the camera, an external object that is spaced less than a specified distance from the first display area and the second display area, transmit, to the external electronic device, a second signal that increases a size of an overlapping area in which the first display area and the second display area overlap, and based on identifying a motion of the external object related to the overlapping area with the increased size increased based on the second signal, display, using the first projection assembly, a visual object with a shape related to the motion within the first display area, the visual object being superimposed on the screen projected onto the first display area by the first projection assembly.

According to an aspect of the disclosure, a method for an electronic device comprising a first projection assembly, includes: identifying, via communication circuitry, an external electronic device including a second projection assembly distinct from the first projection assembly; based on identifying the external electronic device, transmitting to the external electronic device, a first signal for displaying a screen based on a combination of a first display area formed by the first projection assembly and a second display area formed by the second projection assembly; based on identifying, using a camera, an external object that is spaced less than a specified distance from the first display area and the second display area, transmitting, to the external electronic device, a second signal that increases a size of an overlapping area in which the first display area and the second display area overlap; and based on identifying motion of the external object related to the overlapping area with the increased size increased based on the second signal, displaying, using the first projection assembly, a visual object with a shape related to the motion within the first display area, the visual object being superimposed on the screen projected onto the first display area by the first projection assembly.

According to an aspect of the disclosure, an electronic device includes: communication circuitry; a camera; a first projection assembly; at least one processor comprising processing circuitry, the at least one processor being operatively connected with the with the communication circuitry, the camera, and the first projection assembly; and memory comprising one or more storage mediums storing instructions, wherein the instructions, when executed by the at least one processor individually or collectively, cause the electronic device to: identify, via the communication circuitry, an external electronic device including a second projection assembly distinct from the first projection assembly; in a state of displaying a screen based on a combination of a first display area formed by the first projection assembly and a second display area formed by the second projection assembly of the identified external electronic device, identify, using the camera, an external object that is spaced less than a specified distance from the electronic device; based on identifying the external object, control the first projection assembly to move the first display area in a direction in which the second display area is formed to increase a size of an overlapping area in which the first display area and the second display area overlap; identify, based on a motion of the external object, a point within the overlapping area formed by the moved first display area; and generate a visual object that masks a portion of the first display area based on the identified point.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an electronic device according to an embodiment projecting a screen within a display area;

FIG. 2 illustrates an example of a block diagram of an electronic device according to an embodiment;

FIG. 3 is an example signal flowchart indicating a signal transmitted to an external electronic device by an electronic device according to an embodiment;

FIG. 4 illustrates an example of an operation in which an electronic device according to an embodiment adjusts an overlapping area based on identifying an external object;

FIG. 5 illustrates an example of an operation in which an electronic device according to an embodiment generates a transparent layer based on identifying a point;

FIG. 6 illustrates an example of an operation in which an electronic device according to an embodiment generates a transparent layer based on identifying a plurality of points;

FIG. 7 illustrates an example of an operation in which an electronic device according to an embodiment modifies a transparent layer based on identifying movement of a point;

FIG. 8 illustrates an example of an operation in which an electronic device according to an embodiment generates a transparent layer corresponding to one or more media contents;

FIG. 9 illustrates an example of an operation in which an electronic device according to an embodiment generates a visual object based on identifying at least one illuminant;

FIG. 10 illustrates an example of an operation in which an electronic device according to an embodiment generates a visual object to be displayed on an external object;

FIG. 11 illustrates an example of a flowchart indicating an operation of an electronic device according to an embodiment;

FIG. 12 illustrates an example flowchart indicating an electronic device according to an embodiment adjusting a size of an overlapping area;

FIG. 13 illustrates an example of a flowchart indicating an operation of an electronic device according to an embodiment;

FIG. 14 illustrates an example of a flowchart indicating an operation of an electronic device according to an embodiment; and

FIG. 15 is an example diagram of a network environment related to a metaverse service.

### DETAILED DESCRIPTION

Hereinafter, various embodiments of the present document will be described with reference to the accompanying drawings.

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

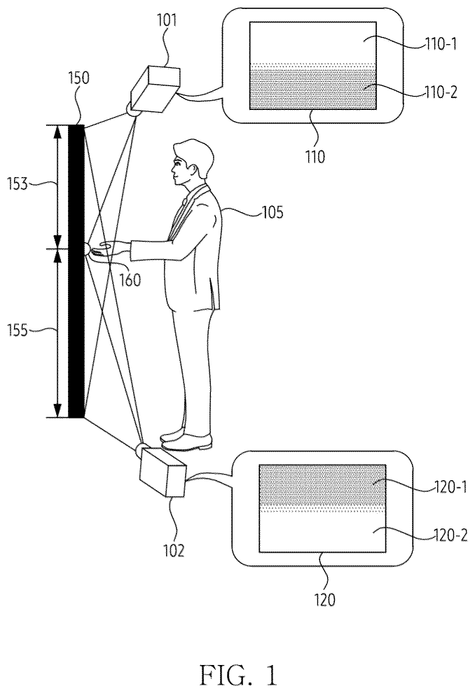

FIG. 1 illustrates an example of an electronic device according to an embodiment projecting a screen within a display area. Referring to FIG. 1, an electronic device 101 according to an embodiment may include a beam projector to emit light to an external space. The electronic device 101 may output the light representing a screen formed by pixels arranged two-dimensionally. The light outputted from the electronic device 101 may be reflected by an object, such as a flat surface 150. Based on the light reflected by the object, a user may view the screen.

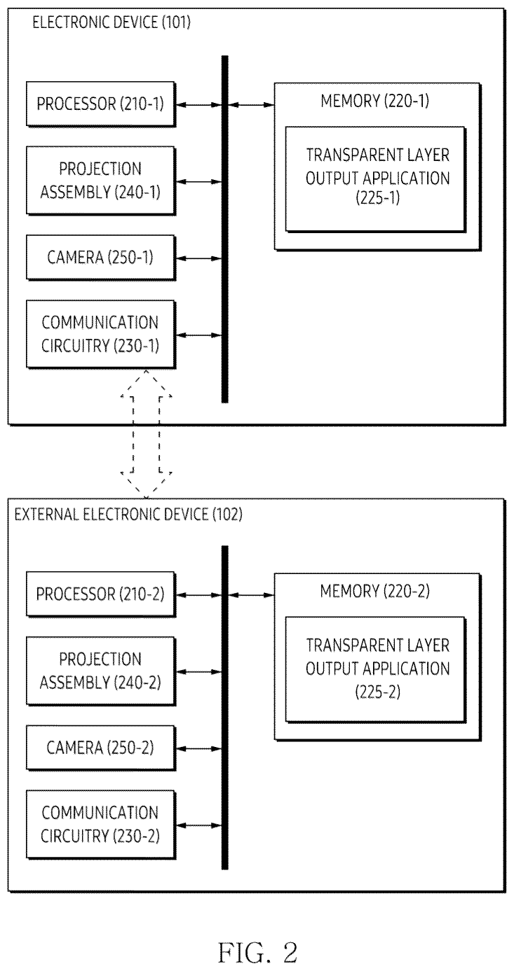

Referring to FIG. 1, according to an embodiment, the electronic device 101 may, in an external space where light emitted by the electronic device 101 is reachable, identify at least one flat surface (e.g., the flat surface 150) that is projectable a screen represented by the light. The electronic device 101 according to an embodiment may identify, using communication circuitry, an external electronic device 102 for projecting light toward the at least one identified flat surface (e.g., the flat surface 150). The external electronic device 102 may include at least a portion of hardware included in the electronic device 101. A block diagram indicating hardware of the electronic device 101 and the external electronic device 102 is described below in FIG. 2.

The electronic device 101 may, in a state of identifying the external electronic device 102, transmit, to the external electronic device 102, a signal indicating a screen to be projected on the flat surface 150. The electronic device 101 may, by transmitting the signal to the external electronic device 102, project the screen overlapping at least a portion of another screen projected from the external electronic device 102 onto the flat surface 150. For example, there may be one or more external electronic devices 102.

According to an embodiment, a first display area on which the electronic device 101 projects a screen and a second display area on which the external electronic device 102 projects another screen may adjoin or be spaced apart from each other in the flat surface 150. Each of the one or more display areas may have a specified ratio (e.g., an aspect ratio) and may have a shape of a quadrangle. However, the disclosure is not limited to the above example embodiment. The electronic device 101 may display a screen in the first display area. The external electronic device 102 may display another screen in the second display area. The electronic device 101 displaying the screen and the external electronic device 102 displaying the other screen may be performed substantially and/or simultaneously performed via a communication link. The screen and the other screen may be obtained by substantially similar information.

In an embodiment, the screen displayed in the first display area by the electronic device 101 may be indicated by image data. For example, the image data may be stored in memory of the electronic device 101 or may be transmitted from another electronic device (e.g., at least one server providing a streaming service, a set-top box (STB), a PC, and/or a TV) to the electronic device 101. The image data may include an image and/or a video. The image data may be streamed from a network connected by the electronic device 101. The image data may include a video and a sound synchronized with the video. The image data may include a video standardized by a Motion Picture Expert Group (MPEG). The other screen displayed in the second display area by the external electronic device 102 may be substantially similar to what is described above.

According to an embodiment, the electronic device 101 may, in a state of displaying a screen on the flat surface 150, identify at least one object (e.g., a user 105) approaching toward the flat surface 150. The electronic device 101 recognizing at least one object may include an operation of identifying a shape and/or a position of the at least one object. For identifying the at least one object, the electronic device 101 may obtain at least one image and/or video with respect to the external space using a camera. Based on the obtained image and/or video, the electronic device 101 may identify at least one object adjacent to the electronic device 101. The electronic device 101 may, based on the obtained image and/or video, identify at least one object spaced less than a specified distance. However, the disclosure is not limited to the above example embodiment. For example, the electronic device 101 may identify, using a sensor, the at least one object (e.g., the user 105) spaced less than the specified distance.

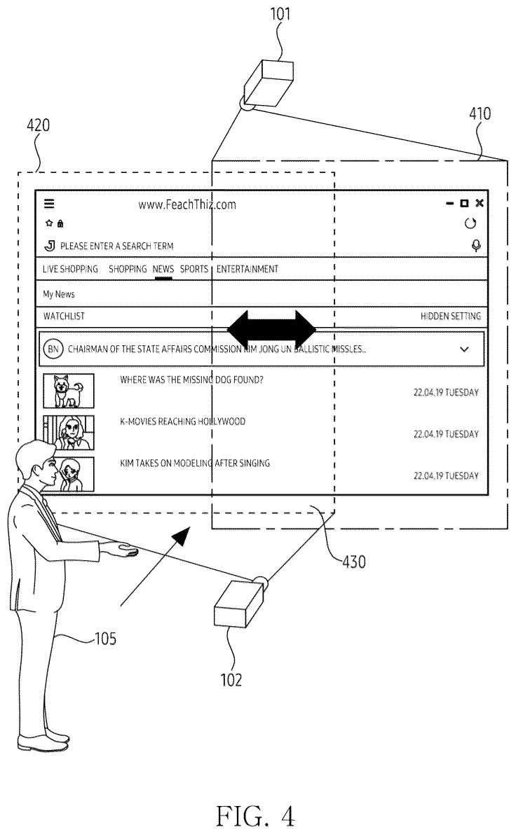

According to an embodiment, the electronic device 101 may, based on identifying, using the camera, the at least one object (e.g., the user 105) spaced less than the specified distance from the electronic device 101, transmit a signal to the external electronic device 102. The signal may include information to increase a size of an overlapping area in which the first display area of the electronic device 101 and the second display area of the external electronic device 102 overlap. The overlapping area may be an area to remove a visual object (e.g., a shadow) generated by the at least one object (e.g., the user 105). The electronic device 101 may move the first display area in a direction in which the second display area is formed based on transmitting the signal to the external electronic device 102. The electronic device 101 adjusting the size of the overlapping area is described below in FIG. 4.

According to an embodiment, the electronic device 101 may identify, using the camera, motion of the at least one object (e.g., the user 105). For example, the motion may include motion of raising an arm of the user 105. Based on identifying the motion, the electronic device 101 may, based on a height and a position of the at least one object, identify a point 160 within the overlapping area. The point 160 within the overlapping area may mean a point where the overlapping area and the at least one object are to be in contact. The electronic device 101 may, based on identifying the motion, predict the point 160.

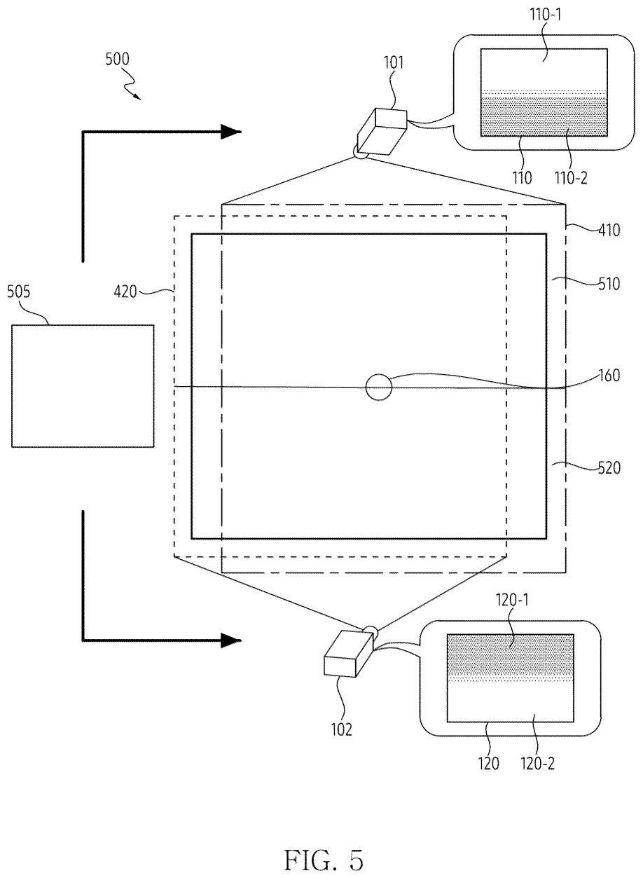

According to an embodiment, the electronic device 101 may, while the electronic device 101 projects a screen onto the first display area, based on identifying the point, generate a transparent layer 110 for projecting toward a first portion 153 among portions of the first display area distinguished by the point, by overlapping the screen. The transparent layer 110 may be an example of a visual object for blocking a portion of the screen projected onto the first display area by the electronic device 101. The transparent layer 110 may have an alpha value and/or transparency related to translucency. The electronic device 101, based on a position of the point 160, may distinguish areas 110-1 and 110-2 (a first portion 110-1 and a second portion 110-2) of the transparent layer 110. The electronic device 101 may generate each of the areas 110-1 and 110-2 of the transparent layer 110 based on different transparency. A shape of the transparent layer 110 may correspond to a shape of a screen projected onto the first display area by the electronic device 101. A size, a color, and/or the alpha value of the transparent layer 110 may be adjusted based on a position, the number, and/or movement of the point 160. An operation of the electronic device 101 generating or modifying the transparent layer 110 is described below in FIGS. 5 to 9.

For example, the electronic device 101 may, based on generating the transparent layer 110, display the transparent layer 110 by overlapping the screen projected onto the first display area. The electronic device 101 may, by displaying the transparent layer 110, project a portion of the screen onto the first portion 153 adjacent to the electronic device 101 among the first portion 153 and a second portion 155 of the flat surface 150.

According to an embodiment, the electronic device 101 may, based on generating the transparent layer 110, transmit, to the external electronic device 102, a signal requesting generating the transparent layer 120 corresponding to the transparent layer 110. The external electronic device 102 may, in response to receiving the signal, obtain the transparent layer 120. The external electronic device 102 may obtain the transparent layer 120 to mask a portion of the second display area of the external electronic device 102. The external electronic device 102 may project a portion of the screen onto the second portion 155 among the first portion 153 and the second portion 155, by displaying the transparent layer 120, while projecting the screen onto the second display area.

For example, the electronic device 101 may, by coupling a portion of the screen projected onto the first portion 153 by the electronic device 101 and another portion of the screen projected onto the second portion 155 by the external electronic device 102, provide the user 105 with an entire screen.

As described above, according to an embodiment, the electronic device 101 may identify the user 105 spaced less than a specified distance using the camera. The electronic device 101 may, while displaying the screen in the first display area, transmit, to the external electronic device 102, a signal requesting displaying of the screen in the second display area overlapped with a portion of the first display area. The electronic device 101 may, in a state of displaying the screen, using the overlapping area in which the first display area and the second display area overlap, identify the point 160 based on motion of the user 105. The electronic device 101 may generate the transparent layer 110 based on identifying the point 160. The electronic device 101 may, by displaying the transparent layer 110 overlapping the screen, prevent a shadow generated by the user 105 on the flat surface 150. The electronic device 101 may provide the user 105 with a screen in which at least one media content included in the screen is not covered, by preventing the shadow using the transparent layer 110.

FIG. 2 illustrates an example of a block diagram of an electronic device according to an embodiment. The electronic device 101 of FIG. 1 may be an example of the electronic device 101 of FIG. 2. The external electronic device 102 of FIG. 1 may be an example of the external electronic device 102 of FIG. 2. Referring to FIG. 2, the electronic device 101 and the external electronic device 102 may be connected to each other based on a wired network and/or a wireless network. The wired network may include a network such as the Internet, a local area network (LAN), a wide area network (WAN), Ethernet, or a combination thereof. The wireless network may include a network such as long term evolution (LTE), 5G new radio (NR), wireless fidelity (WiFi), Zigbee, near field communication (NFC), Bluetooth, Bluetooth low-energy (BLE), or a combination of those wireless networks. Although the electronic device 101 and the external electronic device 102 are illustrated as being directly connected, the electronic device 101 and the external electronic device 102 may be indirectly connected via an intermediate node (e.g., a router and/or an access point (AP)).

Referring to FIG. 2, according to an embodiment, the electronic device 101 may include at least one of a processor 210-1, memory 220-1, communication circuitry 230-1, a projection assembly 240-1, or a camera 250-1. The processor 210-1, the memory 220-1, the communication circuitry 230-1, the projection assembly 240-1, and the camera 250-1 may be electronically and/or operably coupled with each other by an electrical component such as a communication bus. Hereinafter, hardware being operable coupled may mean that a direct or an indirect connection between the hardware is established by wire or wirelessly so that a second hardware among the hardware is controlled by a first hardware. Although the above components are illustrated with different blocks in FIG. 2, the disclosure is not limited to the above example embodiment. A portion (e.g., at least a portion of the processor 210-1, the memory 220-1, and the communication circuitry 230-1) of hardware of FIG. 2 may be included in a single integrated circuitry such as a ‘system-on-a-chip’ (SoC). A type and/or the number of hardware components included in the electronic device 101 are not limited to those illustrated in FIG. 2. For example, the electronic device 101 may include only a portion of the hardware components illustrated in FIG. 2.

According to an embodiment, the processor 210-1 of the electronic device 101 may include a hardware component for processing data based on one or more instructions. The hardware components for processing data may include, for example, an arithmetic and logical unit (ALU), a floating point unit (FPU), a field programmable gate array (FPGA), a central processing unit (CPU), and/or an application processor (AP). The number of processors 210-1 may be one or more. For example, the processor 210-1 may have a multi-core processor structure such as a dual core, a quad core, or a hexa core.

According to an embodiment, the memory 220-1 of the electronic device 101 may include a hardware component for storing data and/or an instruction inputted and/or outputted to the processor 210-1. The memory 220-1 may include, for example, volatile memory such as random-access memory (RAM) and/or non-volatile memory such as read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multimedia card (eMMC).

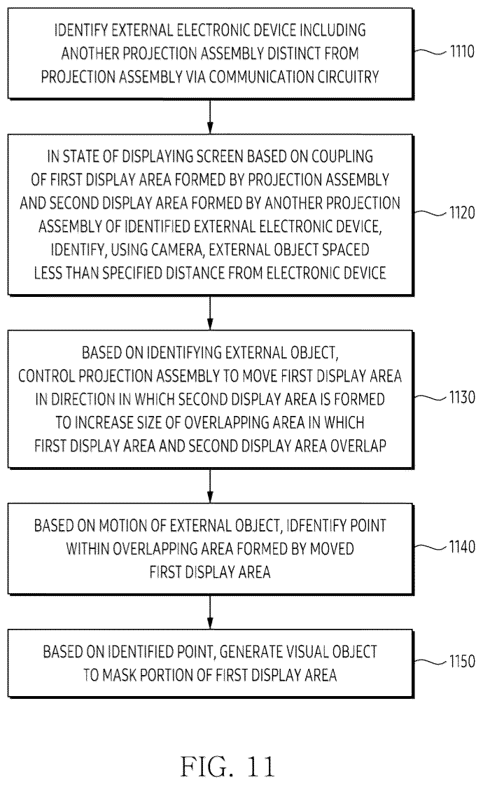

According to an embodiment, in the memory 220-1 of the electronic device 101, one or more instructions (or commands) indicating a computation and/or an operation to be performed on data by the processor 210-1 may be stored. A set of one or more instructions may be referred to as a firmware, an operating system, a process, a routine, a sub-routine and/or an application. For example, the electronic device 101 and/or the processor 210-1 may, when a set of a plurality of instructions distributed in a form of an operating system, a firmware, a driver, and/or an application is executed, perform at least one of operations of FIGS. 11 to 14. Hereinafter, an application being installed in the electronic device 101 may mean that one or more instructions provided in a form of an application are stored in the memory 220-1 of the electronic device 101, and that the one or more applications may be stored in a format (e.g., a file with an extension specified by an operating system of the electronic device 101) executable by the processor 210-1 of the electronic device 101.

According to an embodiment, the electronic device 101 may, based on execution of a transparent layer output application 225-1, generate a transparent layer corresponding to a position of at least one external object (e.g., the user 105 of FIG. 1) obtained via the camera 250-1. The electronic device 101 may mask a portion of a screen to be displayed in a first display area by controlling the projection assembly 240-1 using the generated transparent layer,. An example of an operation indicating the electronic device 101 generating the transparent layer corresponding to the position of the at least one external object based on the execution of the transparent layer output application 225-1 is described below in FIG. 5.

According to an embodiment, the communication circuitry 230-1 of the electronic device 101 may include hardware for supporting transmission and/or reception of an electrical signal between the electronic device 101 and the external electronic device 102. Although only the external electronic device 102 is illustrated as another electronic device connected via the communication circuitry 230-1 of the electronic device 101, the disclosure is not limited to the above example embodiment. The communication circuitry 230-1 may include, for example, at least one of a modem, an antenna, and an optical/electronic (O/E) converter. The communication circuitry 230-1 may support transmission and/or reception of an electrical signal based on various types of protocols such as Ethernet, a LAN, a WAN, WiFi, Bluetooth, BLE, Zigbee, long term evolution (LTE), and 5G new radio (NR).

According to an embodiment, the electronic device 101 may receive, using the communication circuitry 230-1, media content (or information indicating a screen). For example, the electronic device 101 may, via the communication circuitry 230-1, wirelessly receive a signal for displaying the media content, based on a wireless communication protocol such as a wireless display (WiDi) and/or Miracast. For example, the electronic device 101 may, using the communication circuitry 230-1, receive by wire a signal for displaying the media content, based on a wired communication protocol (or a wired interface) such as a high-definition multimedia interface (HDMI), a DisplayPort (DP), a mobile high-definition link (MHL), a digital visual interface (DVI), and/or a D-subminiature (D-sub),.

According to an embodiment, the projection assembly 240-1 of the electronic device 101 may include a plurality of hardware assembled to emit light representing pixels arranged two-dimensionally. For example, the projection assembly 240-1 may include a combination of cathode-ray tubes (CRTs) for emitting light of each of three primary colors in a color space and lenses for magnifying the light emitted from each of the CRTs. For example, the projection assembly 240-1 may include a combination of an illuminant (e.g., a lamp) for emitting light, optical filters for dividing the light into light paths corresponding to each of the three primary colors, liquid crystal display (LCD) panels disposed in each of the light paths, and a prism for synthesizing light outputted from the LCD panels and/or a lens. For example, the projection assembly 240-1 may include a combination of an illuminant for emitting light, an optical filter that selects one of the three primary colors from the light, a digital mirror device (DMD) for adjusting reflection of the primary color filtered by the optical filter, and a lens for magnifying the light reflected by the DMD. In terms of requiring projection of light for displaying a screen, at least one of the exemplified combinations may be referred to as the projection assembly 240-1. In an embodiment, the electronic device 101 including the projection assembly 240-1 may be referred to as a beam projector.

According to an embodiment, the camera 250-1 of the electronic device 101 may include one or more optical sensors (e.g., a charged coupled device (CCD) sensor and a complementary metal oxide semiconductor (CMOS) sensor) that generate an electrical signal indicating a color and/or brightness of light. A plurality of optical sensors in the camera 250-1 may be disposed in a form of a two dimensional array. The camera 250-1 may substantially and/or simultaneously obtain an electrical signal of each of the plurality of optical sensors to correspond to light reaching the optical sensors of a two dimensional array, and generate an image including a plurality of pixels arranged two-dimensionally. For example, photographic data captured using the camera 250-1 may mean an image obtained from the camera 250-1. For example, video data captured using the camera 250-1 may mean a sequence of a plurality of images obtained from the camera 250-1 at a specified frame rate.

According to an embodiment, by using the camera 250-1 included in the electronic device 101, an external object included in the obtained image and/or video may be identified. The electronic device 101 identifying the external object may be performed based on a sensor for identifying a distance between the electronic device 101 and the external object, such as a depth sensor and/or a time-of-flight (ToF) sensor. The depth sensor may include an ultra-wide band (UWB) sensor (or UWB radar) that uses a wireless signal in a frequency band of UWB. The depth sensor may include a time of flight (ToF) sensor that measures ToF of laser light and/or infrared light. The electronic device 101 may obtain a depth video including depth values arranged two-dimensionally, using a ToF sensor. The ToF sensor may include an infrared diode and a plurality of infrared light sensors, detecting an intensity of infrared light, disposed in a form of a two dimensional array. The electronic device 101 may, using a ToF sensor, obtain the depth video based on time when light emitted from the infrared diode is reflected from a subject and reaches at least one of the plurality of infrared light sensors.

Referring to FIG. 2, the external electronic device 102 connected to the electronic device 101 may include at least one of a processor 210-2, memory 220-2, communication circuitry 230-2, a projection assembly 240-2, or a camera 250-2. The processor 210-2, the memory 220-2, the communication circuitry 230-2, the projection assembly 240-2, and the camera 250-2 may be electronically and/or operably coupled with each other by a communication bus. The processor 210-2, the memory 220-2, the communication circuitry 230-2, and the camera 250-2 in the external electronic device 102 of FIG. 2 may correspond to the processor 210-1, the memory 220-1, the communication circuitry 230-1, and the camera 250-1 in the electronic device 101. To reduce repetition of a description, among descriptions of the processor 210-2, the memory 220-2, the communication circuitry 230-2, the projection assembly 240-2, and the camera 250-2, descriptions overlapping the processor 210-1, the memory 220-1, the projection assembly 240-1, and the camera 250-1 may be omitted.

The electronic device 101 according to an embodiment may establish, using the communication circuitry 230-1, a communication link with the external electronic device 102. In a state in which the communication link is established, the electronic device 101 may transmit a signal indicating at least one image to the external electronic device 102. The electronic device 101 may, based on transmitting the signal, project a screen indicating a portion of the at least one image onto the first display area, using the projection assembly 240-1. For example, the external electronic device 102 may, in response to receiving the signal, project another screen indicating another portion of the at least one image onto a second display area, using the projection assembly 240-2. At least a portion of the first display area and at least a portion of the second display area may overlap or be spaced apart. Based on the communication link, the electronic device 101 and the external electronic device 102 may project the screen and/or the other screen substantially and/or simultaneously.

According to an embodiment, the electronic device 101 may, based on identifying at least one external object using the camera 250-1, adjust the first display area in which light of the projection assembly 240-1 is propagated. The electronic device 101 may control the projection assembly 240-1 to modify a position of the first display area in a direction in which the second display area is formed to increase a size of an overlapping area in which the first display area and the second display area of the external electronic device 102 overlap. The electronic device 101 may transmit a signal to increase the size of the overlapping area in which the first display area and the second display area of the external electronic device 102 overlap to the external electronic device 102. The external electronic device 102 may, in response to the signal, adjust a position of the second display area in a direction in which the first display area of the electronic device 101 is formed. The electronic device 101 may identify, based on increasing the size of the overlapping area, a point (e.g., the point 160 in FIG. 1) within the overlapping area adjacent to the at least one external object. The electronic device 101 may obtain, based on identifying the point, a transparent layer for covering a portion of a screen to be displayed as a portion different from a portion adjacent to the electronic device 101, among portions of the first display area. The electronic device 101 may transmit, based on identifying the point, a signal indicating generating another transparent layer for corresponding to the transparent layer and covering a portion of the screen to be displayed as the adjacent portion to the external electronic device 102. An operation of the electronic device 101 obtaining the transparent layer for covering a portion of the screen to be displayed as the different portion and transmitting the signal to the external electronic device 102 is described below in FIGS. 5 to 8.

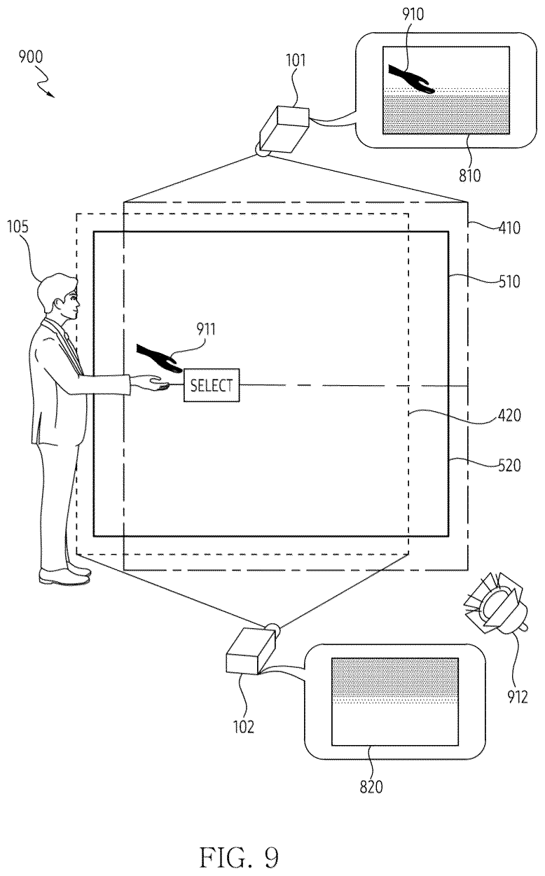

According to an embodiment, the electronic device 101 may identify, using the camera 250-1 and/or a sensor, at least one illuminant in an external space in which the electronic device 101 is disposed. The electronic device 101 may predict a position of a shadow by light emitted from the at least one illuminant within the overlapping area in which the first display area of the electronic device 101 and the second display area of the external electronic device 102 overlap. For example, the electronic device 101 may generate a visual object representing the shadow generated by light emitted from at least one external object (e.g., the user 105 of FIG. 1) and the at least one illuminant. The electronic device 101 may project the generated visual object overlapping the transparent layer onto the first display area by controlling the projection assembly 240-1. An example of an operation of the electronic device 101 generating the visual object by using a position of the at least one illuminant is described below in FIG. 9.

According to an embodiment, the electronic device 101 may generate a visual object to be projected onto a portion (e.g., a hand of the user 105 of FIG. 1) of the at least one external object obtained using the camera 250-1. The electronic device 101 may display the visual object on a portion of the at least one external object by projecting the visual object onto the first display area overlapping the transparent layer. The electronic device 101 may provide, by displaying the visual object, an augmented reality service to a user who uses a screen provided by the electronic device 101 using the projection assembly 240-1.

As described above, according to an embodiment, the electronic device 101 may, in a state in which the communication link is established with the external electronic device 102, generate a transparent layer for blocking a portion of a screen to be projected onto the first display area. The electronic device 101 may, based on identifying motion of the at least one external object (e.g., the user 105 of FIG. 1), identify a point within the overlapping area in which the first display area and the second display area of the external electronic device 102 overlap. The electronic device 101 may, based on identifying the point, generate a transparent layer corresponding to a position of the point. The electronic device 101 may, by generating the transparent layer based on the position of the point, reduce an amount of data for generating the transparent layer. The electronic device 101 may, by generating the transparent layer based on the position of the point, reduce time for generating the transparent layer.

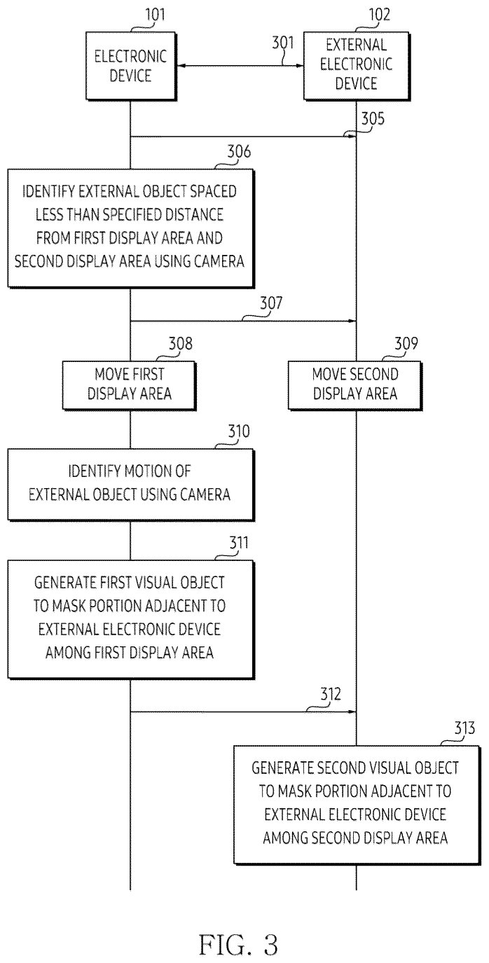

FIG. 3 is an example signal flowchart indicating a signal transmitted to an external electronic device by an electronic device according to an embodiment. An electronic device 101 of FIG. 3 may be an example of the electronic device 101 of FIGS. 1 to 2. An external electronic device 102 of FIG. 3 may be an example of the external electronic device 102 of FIGS. 1 to 2.

Referring to FIG. 3, the electronic device 101 according to an embodiment may identify, using communication circuitry (e.g., the communication circuitry 230-1 of FIG. 2), the external electronic device 102. The electronic device 101 may establish a communication link 301 with the external electronic device 102. The electronic device 101 may, in a state in which the communication link 312 is established, project, using image data stored in memory (e.g., the memory 220-1 of FIG. 2) or received from at least one server, a portion of a screen included in the image data onto a first display area of the electronic device 101. The external electronic device 102 may, in a state in which the communication link 301 is established, display, using image data, another portion different from the portion of the screen on a second display area of the external electronic device 102. For example, the image data used by the external electronic device 102 may be received from the electronic device 101 or may be received from at least one server. The electronic device 101 may provide, using the first display area and the second display area, an entire screen included in the image data to a user. The first display area of the electronic device 101 and the second display area of the external electronic device 102 may include an overlapping area that overlaps at least partially. For example, the overlapping area may be an area in which a first light projected by the electronic device 101 using a projection assembly (e.g., the projection assembly 240-1 of FIG. 2) and a second light projected by the external electronic device 102 using the projection assembly (e.g., the projection assembly 240-2 of FIG. 2) overlap. The electronic device 101 may adjust, by performing edge blending, brightness and/or resolution by an overlap of the first light and the second light. For example, the electronic device 101 may transmit, to the external electronic device 102, a signal 305 to display a screen based on a combination of the first display area formed by the projection assembly 240-1 and the second display area formed by the other projection assembly 240-2 of the external electronic device 102. As an example, the electronic device 101 may transmit the signal 305 to perform the edge blending to the external electronic device 102. The external electronic device 102 may, by performing the edge blending in response to the signal 305, adjust the brightness and/or the resolution by the overlap of the first light and the second light.

According to an embodiment, the electronic device 101 may identify, using the camera 250-1 of FIG. 2, an external object (e.g., the user 105 of FIG. 1) spaced less than a specified distance. For example, in operation 306, the electronic device 101 may identify, using the camera 250-1, an external object that is spaced less than a specified distance from the first display area and the second display area.

According to an embodiment, the electronic device 101 may, based on identifying the external object, adjust a size of the overlapping area. In operation 308, the electronic device 101 may move the first display area. For example, the electronic device 101 may, to adjust the size of the overlapping area, control the projection assembly 240-1 to adjust a position and/or a size of the first display area of the electronic device 101 in a direction in which the second display area of the external electronic device 102 is formed. The electronic device 101 may transmit a signal 307 for adjusting the size of the overlapping area to the external electronic device 102.

For example, in operation 309, the external electronic device 102 may move the second display area. The external electronic device 102 may, in response to receiving the signal 307, control the projection assembly 240-2 to adjust a position and/or a size of the second display area in a direction in which the first display area is formed. The electronic device 101 and/or the external electronic device 102 may increase the size of the overlapping area by moving the first display area and/or the second display area.

According to an embodiment, in operation 310, the electronic device 101 may identify motion of the external object using the camera. The motion of the external object may include motion of the user (e.g., the user 105 of FIG. 1) raising an arm. Based on the motion, the electronic device 101 may identify a point (e.g., the point 160 in FIG. 1) within the overlapping area using the camera, based on a position and/or a height of the arm of the user. For example, the electronic device 101 may predict the point within the overlapping area adjacent to the external object approaching the overlapping area by the motion. The electronic device 101 may, based on predicting the point, identify a first portion and a second portion which are distinguished by the point in the first display area of the electronic device 101. The first portion may be a portion adjacent to the electronic device 101 among the portions of the first display area. The second portion may be a portion adjacent to the external electronic device 102.

According to an embodiment, in operation 311, the electronic device 101 may generate a first visual object to mask a portion of the first display area adjacent to the external electronic device. The adjacent portion may mean the first portion. A size of the first visual object may be substantially similar to a size of the screen included in the image data to be projected onto the first display area. The first visual object may include areas corresponding to the first portion and the second portion of the first display area distinguished by the point. The electronic device 101 may, based on execution of the transparent layer output application 225-1 of FIG. 2, generate the first visual object. For example, based on generating the first visual object, the electronic device 101 may project the first visual object onto the first display area by overlapping a portion of the screen included in the image data. For example, the electronic device 101 may, based on generating the first visual object, transmit a signal 312 indicating generating of a second visual object corresponding to the first visual object to the external electronic device 102.

For example, in response to receiving the signal 312, in operation 313, the external electronic device 102 may generate the second visual object to mask a portion of the second display area adjacent to the electronic device. A shape and/or a size of the second visual object may be substantially similar to a shape and/or a size of the first visual object. A color and/or transparency of areas of the second visual object may be substantially similar to a color and/or transparency of the areas of the first visual object. The external electronic device 102 may, based on generating the second visual object, project the second visual object onto the second display area by overlapping another portion of the screen included in the image data.

As described above, according to an embodiment, the electronic device 101 may remove, based on identifying the motion of the external object using the camera, a shadow of the external object generated by light projected from the projection assembly 240-1. The electronic device 101 may use a transparent layer to remove the shadow of the external object. The electronic device 101 may, based on identifying the motion of the external object, a point at which the external object will be in contact with the overlapping area. The electronic device 101 may, based on predicting the point, adjust a size and/or a shape of the transparent layer. The electronic device 101 may, before identifying the contact between the point and the external object based on identifying the motion of the external object, prevent the shadow of the external object to be generated by the light more quickly by generating the transparent layer using the point.

FIG. 4 illustrates an example of an operation in which an electronic device according to an embodiment adjusts an overlapping area based on identifying an external object. An electronic device 101 of FIG. 4 may be an example of the electronic device 101 of FIGS. 1 to 3. An external electronic device 102 of FIG. 4 may be an example of the external electronic device 102 of FIGS. 1 to 3.

Referring to FIG. 4, according to an embodiment, the electronic device 101 may project, using the projection assembly 240-1 of FIG. 2, a portion of a screen indicated by image data stored in memory or received from an external sever, onto a first display area 410. For example, the external electronic device 102 may project, using the projection assembly 240-2 of FIG. 2, another portion different from the portion of the screen indicated by the image data onto a second display area 420. As an example, the electronic device 101 may transmit, to the external electronic device 102, a signal indicating the other portion of the screen indicated by the image data. The external electronic device 102 may project the other portion, in response to receiving the signal. The electronic device 101 and/or the external electronic device 102 may link the portion of the screen projected onto the first display area 410 and/or the other portion of the screen projected onto the second display area 420 to display the entire screen in an area in which the first display area 410 and the second display area 420 are coupled. The electronic device 101 may, in a state in which the communication link is established, link with the external electronic device 102 to provide a wide-sized video service to the user using the first display area 410 and/or the second display area 420.

According to an embodiment, the electronic device 101 may, in a state in which the communication link is established with the external electronic device 102, identify an external object (e.g., a user 105) spaced less than a specified distance from the electronic device 101 using a camera (e.g., the camera 250-1 of FIG. 2). For example, the electronic device 101 may identify, using the camera, the user 105 spaced less than a specified distance from the first display area 410 and/or the second display area 420.

For example, the electronic device 101 may, based on identifying the user 105, adjust a size of an overlapping area 430 in which the first display area 410 and the second display area 420 overlap. To increase the size of the overlapping area 430, the electronic device 101 may control the projection assembly 240-1 of FIG. 2 to adjust the first display area 410 in a direction in which the second display area 420 is formed. The electronic device 101 may transmit a signal for adjusting the size of the overlapping area 430 to the external electronic device 102.

For example, the external electronic device 102 may, in response to the signal, control the projection assembly 240-2 of FIG. 2 to adjust the second display area 420 in a direction in which the first display area 410 is formed. The electronic device 101 and/or the external electronic device 102 may increase the size of the overlapping area 430 by controlling a projection assembly (e.g., the projection assembly 240-1 or the projection assembly 240-2 of FIG. 2) to adjust a direction of the first display area 410 and/or the second display area 420.

According to an embodiment, the electronic device 101 may identify, using the image data, at least one media content in a screen indicated by the image data. The at least one media content may mean media content that may receive an input from an external object. The input may include a touch input. For example, the electronic device 101 may perform a function corresponding to the at least one media content in response to receiving a touch input indicating that the at least one media content is selected within the overlapping area 430. For example, the at least one media content may include a pop-up window. However, the disclosure is not limited to the above example embodiment. For example, the electronic device 101 may, based on distinguishing a graphic user interface (GUI) component (e.g., an icon, a color, text, and/or a layout) included in a screen, identify the at least one media content.

For example, the electronic device 101 may adjust, based on identifying at least one media content, using a size of the at least one media content, the size of the overlapping area 430. The electronic device may adjust, in a case that the at least one media content in the screen is not identified, the size of the overlapping area 430 so that the entire screen is included within the overlapping area 430. However, the disclosure is not limited to the above example embodiment. For example, the electronic device 101 may adjust the size of the overlapping area 430 so that a portion for removing a shadow in a screen is projected onto the overlapping area 430.

According to an embodiment, the electronic device 101 may include a motor and/or an actuator to control the projection assembly 240-1 of FIG. 2. The electronic device 101 may modify a direction of the projection assembly 240-1 using the motor and/or the actuator to adjust the size of the overlapping area 430. By modifying the direction of the projection assembly 240-1, the electronic device 101 may modify a position of the first display area 410.

As described above, according to an embodiment, the electronic device 101 may identify the user 105 using the camera, in a state of being linked with the external electronic device 102, using the communication link established with the external electronic device 102. The electronic device 101 may adjust, based on identifying a distance between the electronic device 101 and the user 105, which is less than a specified distance, the size of the overlapping area 430. For example, the electronic device 101 may identify media content included in a screen to be projected onto the first display area 410. The electronic device 101 may adjust the size of the overlapping area 430 corresponding to a size of the identified media content. The electronic device 101 may adjust the size of the overlapping area 430 corresponding to a size of the screen. The electronic device 101 may improve accuracy of an operation for identifying a position of an external object adjacent to the overlapping area 430 by adjusting the size of the overlapping area 430 using a screen and/or media content included in the screen. Hereinafter, an example of an operation of an electronic device 101 obtaining a point within the overlapping area 430 based on identifying the position of the external object is described below in FIG. 5.

FIG. 5 illustrates an example of an operation in which an electronic device according to an embodiment generates a transparent layer based on identifying a point. An electronic device 101 of FIG. 5 may be an example of the electronic device 101 of FIGS. 1 to 4. An external electronic device 102 of FIG. 5 may be an example of the external electronic device 12 of FIGS. 1 to 4. Referring to FIG. 5, according to an embodiment, a state 500 in which the electronic device 101 according to an embodiment establishes a communication link with the external electronic device 102 through communication circuitry is illustrated. The electronic device 101 may link at least one data with the external electronic device 102 in a state in which the communication link is established. The state 500 may include a state in which the user 105 of FIG. 4 is spaced less than a specified distance.

Referring to FIG. 5, according to an embodiment, the electronic device 101 may identify image data 505 stored in memory (e.g., the memory 230 of FIG. 2) or received from another electronic device (e.g., a server). For example, the external electronic device 102 may identify the image data 505. The electronic device 101 and/or the external electronic device 102 may, based on identifying the image data 505, display a screen indicated by the image data 505 on a first display area 410 and/or a second display area 420. The electronic device 101 may display the screen based on a coupling of the first display area 410 and the second display area 420. For example, the screen indicated by the image data 505 may be at least partially included in an overlapping area (e.g., the overlapping area 430 of FIG. 4).

According to an embodiment, the electronic device 101 may identify, using a camera, motion of an external object (e.g., the user 105 of FIG. 1). The electronic device 101 may identify, based on identifying the motion, a position and/or a height of a portion (e.g., a hand of the user 105 of FIG. 1) of the external object. The electronic device 101 may obtain, using the position and/or the height of the portion, a point 160 adjacent to the portion within the overlapping area. The electronic device 101 may distinguish, based on obtaining the point 160, the first display area 410. For example, the electronic device 101 may distinguish, based on a position of the point 160, the first display area 410 by a first portion 510 adjacent to the electronic device 101 and/or a second portion 520 adjacent to the external electronic device 102.

For example, the electronic device 101 may generate, based on identifying the motion, a transparent layer 110 related to the motion. The electronic device 101 may obtain, based on distinguishing the first display area 410, the transparent layer 110. The electronic device 101 may obtain, based on execution of the transparent layer output application 225-1 of FIG. 2, the transparent layer 110. The transparent layer 110 may be referred to the transparent layer 110 of FIG. 1. A size and/or a shape of the transparent layer 110 may correspond to a size and/or a shape of the screen indicated by the image data 505. The electronic device 101 may generate the transparent layer 110 to mask the second portion 520 among the first portion 510 and the second portion 520 of the first display area 410. Each of portions 110-1 and 110-2 of the transparent layer 110 may correspond to the first portion 510 and the second portion 520. For example, the first portion 110-1 of the transparent layer 110 corresponding to the first portion 510 may be generated using an alpha value based on a value (e.g., 0) smaller than the second portion 110-2 of the transparent layer 110. The second portion 110-2 of the transparent layer 110 corresponding to the second portion 520 may be generated using an alpha value based on a value (e.g., 255) greater than the first portion 110-1 of the transparent layer 110. However, the disclosure is not limited to the above example embodiment. For example, the number, a position and a size of each of portions of the first display area 410, and/or the number, a position, and a size of each of portions of the transparent layer 110 may be modified according to a position, and a distance at which the electronic device 101 is disposed in a space.

According to an embodiment, the electronic device 101 may control a projection assembly (e.g., the projection assembly 240-1 of FIG. 2) to display the transparent layer 110 overlapping the screen displayed in the first display area 410. For example, the electronic device 101 may project, via the first portion 110-1 of the transparent layer 110, a portion of the screen corresponding to the first portion 510 in the first portion 510. The electronic device 101 may, using the second portion 110-2 of the transparent layer 110, temporarily block another portion of the screen corresponding to the second portion 520 from being displayed in the second portion 520.

For example, by light projected from the projection assembly (e.g., the projection assembly 240-1 of FIG. 2) onto the second portion 520, a shadow corresponding to an external object (e.g., the hand of the user 105 of FIG. 1) in contact with the point 160 may appear on the second portion 520. The electronic device 101 may prevent the shadow appeared by the external object in contact with the point 160 by temporarily blocking another portion of the screen from being displayed in the second portion 520 using the transparent layer 110.

According to an embodiment, the electronic device 101 may, based on generating the transparent layer 110, transmit, to the external electronic device 102, a signal requesting generating of a transparent layer 120 different from the transparent layer 110.

For example, based on receiving the signal, the external electronic device 102 may obtain the transparent layer 120 based on execution of the transparent layer output application 225-2 of FIG. 2. For example, the external electronic device 102 may, based on receiving information indicating the transparent layer 120 from the electronic device 101, obtain the transparent layer 120. The portions 120-1 and 120-2 of the transparent layer 120 may be generated based on a different alpha value. For example, an alpha value (e.g., approximately 255) with respect to the first portion 120-1 of the transparent layer 120 corresponding to the first portion 510 may be greater than an alpha value (e.g., approximately zero (0)) with respect to the second portion 120-2 of the transparent layer 120 corresponding to the second portion 520. However, the disclosure is not limited to the above example embodiment. The external electronic device 102 may mask a portion of a screen displayed in the first portion 510 by displaying the transparent layer 120 superimposed on the screen displayed in the second display area 420.

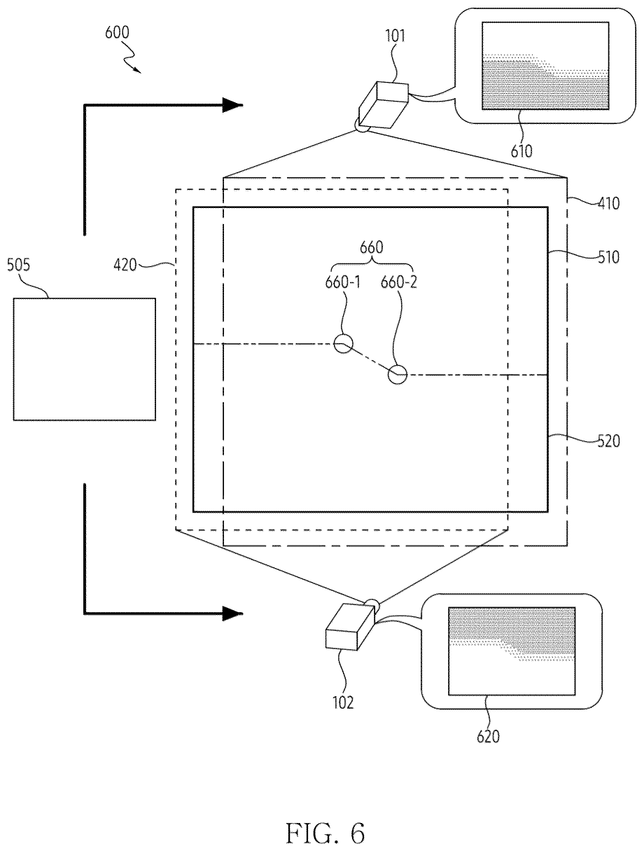

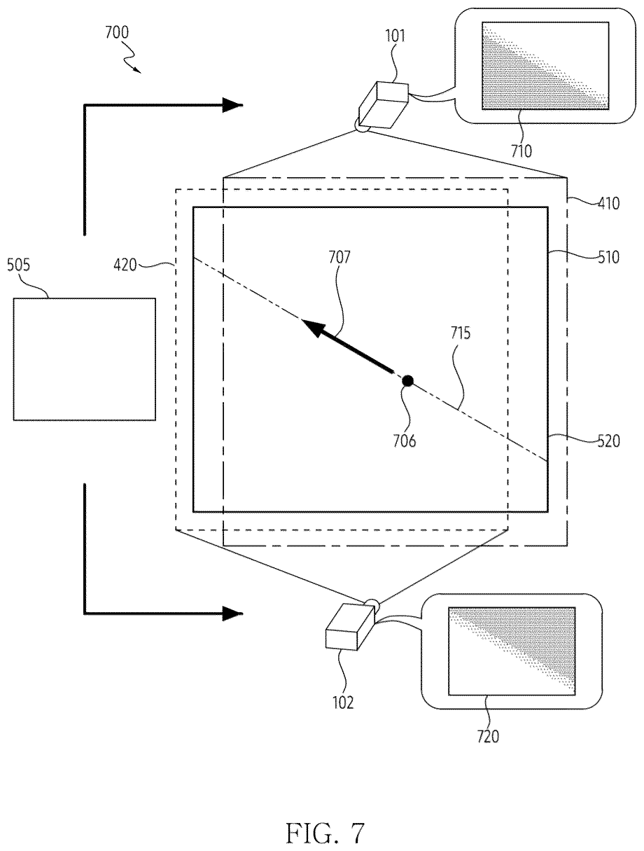

According to an embodiment, the electronic device 101 may track the external object (e.g., the hand of the user 105 of FIG. 1) and/or the point 160 in contact with the external object within the overlapping area (e.g., the overlapping area 430 of FIG. 4) using the camera in an overlapping state of displaying the screen indicated by the image data 505 and the transparent layer 110. The electronic device 101 may, based on tracking the external object and/or the point 160, update the transparent layer 110. An operation of the electronic device 101 updating the transparent layer 110 is described below in FIGS. 6 to 7.

As described above, according to an embodiment, the electronic device 101 may predict, using the camera, the point 160 within the overlapping area to be in contact with the external object based on identifying the motion of the external object. The electronic device 101 may obtain the transparent layer 110 to mask one portion among portions distinguished by the predicted point 160. The electronic device 101 may prevent generation of a shadow by an external object by displaying the transparent layer 110 overlapped with a screen indicated from the image data 505. The electronic device 101 may reduce a delay for removing a shadow that may be generated from the motion of the external object by generating the transparent layer 110 based on predicting the point 160.

FIG. 6 illustrates an example of an operation in which an electronic device according to an embodiment generates a transparency layer based on identifying a plurality of points. FIG. 7 illustrates an example of an operation in which an electronic device according to an embodiment modifies a transparency layer based on identifying movement of a point.

An electronic device 101 of FIGS. 6 and 7 may be an example of the electronic device 101 of FIGS. 1 to 5. An external electronic device 102 of FIGS. 6 and 7 may be an example of the external electronic device 102 of FIGS. 1 to 5. Referring to FIG. 6, a state 600 in which the electronic device 101 and/or the external electronic device 102 display a screen based on image data 505 in a first display area 410 and/or a second display area 420 is illustrated. The state 600 may include the state 500 of FIG. 5.

Referring to FIG. 6, according to an embodiment, the electronic device 101 may identify points 660 based on identifying motion of an external object using a camera. For example, at least one of the points 660 may be referred to the point 160 of FIG. 5. For example, the points 660 may be identified substantially and/or simultaneously based on motion of the external object or may be identified based on a specified time difference. For example, the electronic device 101 may predict, based on motion (e.g., motion of a user raising both hands) of an external object, the points 660. The electronic device may identify an external object in contact with the points 660. For example, the electronic device 101 may identify, while displaying a transparent layer corresponding to a point 660-1, an external object in contact with point 660-2 by tracking the external object using the camera. The electronic device 101 may identify, based on identifying motion of an external object indicating a multi-touch of the external object corresponding to the points 660, the points 660. However, the disclosure is not limited to the above example embodiment.

According to an embodiment, based on identifying the points 600, for example, the electronic device 101 may update the portions 510 and 520 of FIG. 5 based on identifying the points 660. For example, the electronic device 101 may identify portions 510 and 520 of the first display area 410 distinguished by the points 660. For example, the electronic device 101 may obtain, based on identifying the portions 510 and 520, a transparent layer 610 corresponding to the portions 510 and 520. For example, the electronic device 101 may, based on identifying the portions 510 and 520, modify a shape of the portions 110-1 and 110-2 of the transparent layer 110 of FIG. 5. The electronic device 101 may obtain the transparent layer 610 corresponding to the shape of the portions 510 and 520. The electronic device 101 may display the transparent layer 610 by overlapping the screen displayed in the first display area 410. The electronic device 101 may block a portion of a screen displayed as the second portion 520 by displaying the transparent layer 610.

According to an embodiment, the electronic device 101 may, based on identifying the points 660, transmit, to the external electronic device 102, a signal requesting generating a transparent layer 620. For example, the external electronic device 102 may obtain the transparent layer 620 in response to the signal. The external electronic device 102 may, based on a shape of portions of a second display area, generate the transparent layer 620. The external electronic device 102 display the transparent layer 620 by overlapping the second display area 420.

For example, in a case that a position of the points 660 within the overlapping area corresponds to a vertical line or a horizontal line, the electronic device 101 may transmit the signal requesting generating a transparent layer to another external electronic device different from the external electronic device 102. The other external electronic device may be disposed adjacent to an edge, excluding an edge adjacent to the electronic device 101 and an edge adjacent to the external electronic device 102, among edges of the first display area. The electronic device 101 may prevent, using the external electronic device 102 and/or the other external electronic device, a shadow by an external object to be displayed on the screen based on generating a plurality of transparent layers.

Referring to FIG. 7, according to an embodiment, a state 700 in which the electronic device 101 displays the screen based on the image data 505 in the first display area 410 in a state of establishing a communication link with the external electronic device 102 is illustrated. The state 700 may include the state 500 of FIG. 5.

Referring to FIG. 7, according to an embodiment, the electronic device 101 may identify, using a camera, motion of an external object (e.g., the user 105 of FIG. 1). The electronic device 101 may identify a point 706 within an overlapping area (e.g., the overlapping area 430 of FIG. 4) in which a portion (e.g., a hand of the user 105 of FIG. 1) of the external object is in contact. The point 706 may be referred to the point 160 of FIG. 1.

For example, the electronic device 101 may obtain a transparent layer (e.g., the transparent layer 110 of FIG. 5) based on identifying the point 706. The electronic device 101 may identify, while displaying the transparent layer in the first display area 410, using the camera, movement of the point 706. The electronic device 101 may obtain, based on identifying the movement of the point 706, a path 707 along which the point 706 has been moved. For example, the electronic device 101 may identify the motion of the external object in contact with the point 706 using the camera. The identified motion may mean motion of moving along the path 707 from the point 706. The identified motion may be referred to a drag gesture and/or a swipe gesture to move a visual object corresponding to the point 706 along the path 707.

According to an embodiment, the electronic device 101 may distinguish, based on a boundary line 715 corresponding to the path 707, portions of the first display area 410 based on identifying the motion. The electronic device 101 may obtain a transparent layer 710 corresponding to portions 510 and 520 distinguished by the boundary line 715. The electronic device 101 may control the projection assembly 240-1 of FIG. 2 to project the transparent layer 710 overlapping the screen based on the image data 505.

For example, the electronic device 101 may, based on identifying the motion, transmit, to the external electronic device 102, a signal corresponding to the portions 510 and 520 and requesting generating a transparent layer 720 related to the transparent layer 710. The external electronic device 102 may block, using the transparent layer 720, a portion of a screen to be displayed on the first portion 510.

For example, the electronic device 101 may, based on a type of media content corresponding to the point 706 included in a screen, predict the path 707. The electronic device 101 may generate, based on predicting the path 707, the transparent layer 710 before identifying an input for the point 706. However, the disclosure is not limited to the above example embodiment.

For example, in a case that the path 707 corresponds to a vertical line and/or a horizontal line, the electronic device 101 may transmit a signal requesting generating a transparent layer to another external electronic device different from the external electronic device 102. The electronic device 101 may, based on a plurality of transparent layers generated using the external electronic device 102 and/or the other external electronic device, reduce the number of times a shadow of an external object is generated by light projected from at least one projection assembly that will appear on the first display area 410.

As described above, the electronic device 101 may adjust, based on identifying motion of a user or movement and/or the number of points within the overlapping area using the camera, a size, a color, transparency, and/or a shape of a transparent layer. The electronic device 101 may, by adjusting the transparent layer according to the motion of the user or the movement and/or the number of the points, prevent a shadow from appearing on the display area in advance and reduce a delay for removing the shadow.

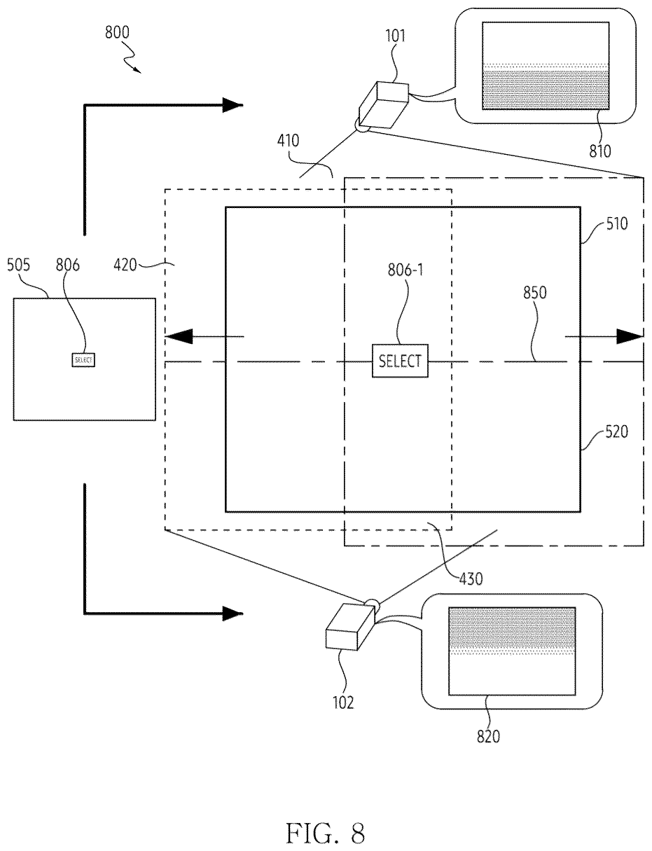

FIG. 8 illustrates an example of an operation in which an electronic device according to an embodiment generates a transparent layer corresponding to one or more media contents. An electronic device 101 of FIG. 8 may be an example of the electronic device 101 of FIGS. 1 to 7. An external electronic device 102 of FIG. 8 may be an example of the external electronic device 102 of FIGS. 1 to 7. Referring to FIG. 8, the electronic device 101 illustrates a state 800 in which an external object (e.g., the user 105 of FIG. 1) is spaced less than a specified distance using a camera.

Referring to FIG. 8, according to an embodiment, in the state 800, the electronic device 101 may identify media content 806 included in a screen indicated by image data 805. For example, the media content 806 may have a layout based on a specified shape (e.g., a width, a height and/or a size). The layout may be related to a size and/or a position of at least one visual object included in the media content 806. The layout may be an arrangement of a plurality of visual objects included in the media content 806. The visual object may mean a deployable object in a screen for transmission and/or interaction of information, such as text, an image, an icon, a video, a button, a check box, a radio button, a text box, and/or a table. As an example, the media content 806 may include a pop-up window displayed superimposed on the screen. The electronic device 101 may, based on identifying the layout, identify the media content 806 in the screen. For example, the media content 806 may be one or more. For example, the media content 806 may be used to receive a user input. For example, the electronic device 101 may identify, using media content 806-1, the user input. For example, the electronic device 101 may predict, using a position of the media content 806-1, motion (e.g., a height and/or a movement direction of an arm) of the user.

According to an embodiment, the electronic device 101 may, based on a size of the media content 806, adjust a size of an overlapping area 430. For example, while displaying a screen, the electronic device 101 may identify a size of the media content 806-1 displayed in a first display area 410 and/or a second display area 420 using the camera. The electronic device 101 may, based on the identified size, adjust the size of the overlapping area 430.

For example, the electronic device 101 may transmit a signal indicating adjustment of the size of the overlapping area 430 to the external electronic device 102. The electronic device 101 may, based on transmitting the signal, adjust the first display area 410 in a direction opposite to an area in which the second display area 420 is formed. The external electronic device 102 may adjust, in response to the signal, the second display area 420 in a direction opposite to an area in which the first display area 410 is formed. However, the disclosure is not limited to the above example embodiment. For example, the electronic device 101 may adjust, in accordance with the size of the media content 806-1, a size of the first display area 410.

According to an embodiment, the electronic device 101 may obtain information for generating transparent layers 810 and 820 from a position of the media content 806 in a screen. For example, the electronic device 101 may identify a boundary line 850 based on the position of the media content 806-1 displayed in the first display area 410 and/or the second display area 420. The electronic device 101 may, based on the boundary line 850, distinguish the screen as a first portion 510 and a second portion 520. The electronic device 101 may generate the transparent layer 810 corresponding to the first portion 510 and the second portion 520. The electronic device 101 may display the transparent layer 810 by overlapping a screen displayed in the first display area 410. The electronic device 101 may block a portion of a screen displayed as the second portion 520 by displaying the transparent layer 810.

According to an embodiment, the electronic device 101 may identify, using the camera, motion of a user (e.g., the user 105 of FIG. 1) indicating hovering on the screen displayed in the first display area 410 and/or the second display area 420. The electronic device 101 may update, in a state of identifying the motion of the user indicating the hovering, the transparent layer 810 based on identifying the height of the arm of the user and/or the movement direction of the user. For example, the electronic device 101 may, based on updating the transparent layer 810, transmit a signal to the external electronic device 102 for updating the transparent layer 820 corresponding to the transparent layer 810. The external electronic device 102 may, in response to the signal, update the transparent layer 820.

As described above, the electronic device 101 may identify the media content 806 in the screen indicated by the image data 805. The electronic device 101 may, based on the position of the media content 806 in the screen, generate the transparent layer 810. The electronic device 101 may mask, using the transparent layer 810, a portion of a screen to be displayed in the second portion among the first portion and the second portion. The electronic device 101 may prevent a shadow to be generated by light before receiving the user input for the media content 806-1 by generating the transparent layer 810 based on the position of the media content 806,. The electronic device 101 may reduce a delay for generating the transparent layer 810 corresponding to the user input by generating the transparent layer 810 before receiving the user input. The electronic device 101 may identify, using the camera, the user motion indicating the hovering around the media content 806-1. The electronic device 101 may provide an optimal transparent layer for removing a shadow to be generated by the user motion by modifying the transparent layer corresponding to the user motion indicating the hovering.

FIG. 9 illustrates an example of an operation in which an electronic device according to an embodiment generates a visual object based on identifying at least one illuminant. An electronic device 101 of FIG. 9 may be an example of the electronic device 101 of FIGS. 1 to 8. An external electronic device 102 of FIG. 9 may be an example of the external electronic device 102 of FIGS. 1 to 8. Referring to FIG. 9, a state 900 in which the electronic device 101 according to an embodiment identifies at least one illuminant 912 using a camera is illustrated. The state 900 of FIG. 9 may include the state 800 of FIG. 8.

According to an embodiment, the electronic device 101 may identify at least one illuminant 912 using a camera (e.g., the camera 250-1 of FIG. 2). The electronic device 101 may identify a positional relationship between the identified at least one illuminant 912 and a first display area 410. The electronic device 101 may, based on the identified positional relationship, predict light emitted from the at least one illuminant 912 and a shadow to be generated by a user 105. For example, the electronic device 101 may predict, using media content 806-1, a position of a hand of the user 105. The electronic device 101 may generate, using the positional relationship and the predicted position of the hand, a visual object 910. As an example, the at least one illuminant 912 may be obtained by image data (e.g., the image data 805 of FIG. 8). The electronic device 101 may generate the visual object 910 using the at least one illuminant included in a screen obtained by the image data and the position of the hand of the user.

For example, the visual object 910 may be generated based on a shape of a shadow to be generated by light emitted from the at least one illuminant 912 and the hand of the user. The electronic device 101 may generate the visual object 910 with a shape of a shadow generated by light projected from the at least one illuminant 912 to the user 105. For example, the electronic device 101 may display the visual object 910 based on a position of the shadow to be generated using the positional relationship and the predicted position of the hand.

According to an embodiment, the electronic device 101 may generate a transparent layer 810 including the visual object 910. For example, an alpha value indicating transparency corresponding to the visual object 910 may be smaller than an alpha value corresponding to a portion (e.g., the second portion 110-2 of FIG. 5) of the transparent layer 810. As an example, the electronic device 101 may modify transparency of a visual object 911 to be displayed in the screen by adjusting the alpha value of the visual object 910. However, the disclosure is not limited to the above example embodiment.

For example, a position and/or a shape of the visual object 910 may vary according to a position of the at least one illuminant 912 and a position of the user 105. The electronic device 101 may project the visual object 911 onto the screen by displaying the transparent layer 810 including the visual object 910 overlapping a screen displayed in the first display area 410. For example, the electronic device 101 may display the visual object 911 in a first portion 510 while blocking a portion of a screen to be displayed on a second portion 520 by the transparent layer 810.

According to an embodiment, the electronic device 101 may, based on the position of the at least one illuminant 912 and/or the position of the user 105, transmit a signal for requesting generating a transparent layer 820 including a visual object to the external electronic device 102. The external electronic device 102 may generate, in response to the signal, the transparent layer 820 including a visual object indicating a shadow of the user 105.

As described above, according to an embodiment, the electronic device 101 may predict, using the camera, a shadow according to a positional relationship of the at least one illuminant and the user. The electronic device 101 may generate a visual object representing the shadow. The electronic device 101 may provide the user with a sense of immersion for a screen projected onto the first display area 410 and/or a second display area 420 by displaying the visual object on a portion of the first display area 410 based on the positional relationship.

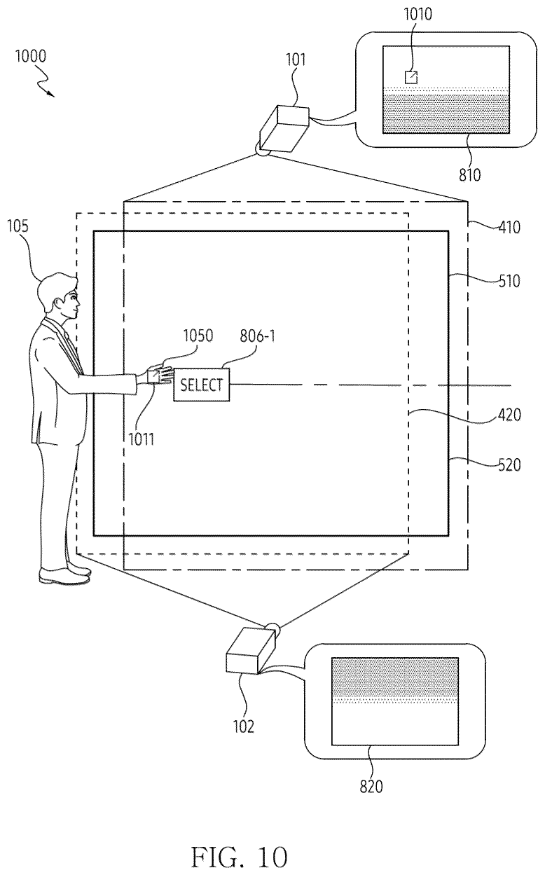

FIG. 10 illustrates an example of an operation in which an electronic device according to an embodiment generates a visual object to be displayed on an external object. An electronic device 101 of FIG. 10 may be an example of the electronic device 101 of FIGS. 1 to 9. An external electronic device 102 of FIG. 10 may be an example of the external electronic device 102 of FIGS. 1 to 9. Referring to FIG. 10, a state 1000 in which the electronic device 101 according to an embodiment projects a visual object 1011 onto a hand 1050 based on identifying the hand 1050 of a user 105. The state 1000 may include the state 800 of FIG. 8.

According to an embodiment, the electronic device 101 may, in a state of displaying a transparent layer 810 overlapped with a first display area 410, using a camera, identify the hand 1050 of the user 105. The electronic device 101 may obtain a visual object 1010 related to image data (e.g., the image data 805 of FIG. 8) based on identifying the hand 1050 of the user 105. The electronic device 101 may generate the visual object 1010 to be displayed on the hand 1050 of the user 105 based on a position of the hand 1050 of the user.

For example, the visual object 1010 may be variously generated according to content provided by the image data. For example, the electronic device 101 may generate, in response to an input indicating to select media content 806-1, the visual object 1010 indicating initiation of an operation corresponding to the media content 806-1. As an example, the electronic device 101 may generate a visual object based on a service (e.g., game content) provided by the image data and for displaying on the entire hand 1050 of the user 105.

According to an embodiment, the electronic device 101 may, based on the position of the hand 1050 of the user 105, generate the visual object 1010 in the transparent layer 810. The visual object 1010 may include color information. For example, the electronic device 101 may generate the visual object 1010 in a portion (e.g., the first portion 110-1 of FIG. 5) of the transparent layer 810 corresponding to a first portion 510. The electronic device 101 may project the visual object 1011 corresponding to the visual object 1010 onto the hand 1050 of the user 105 by displaying the transparent layer 810 including the visual object 1010, superimposed on a screen displayed in the first display area 410. For example, the electronic device 101 may transmit a signal indicating generating the visual object to be displayed on the hand 1050 to the external electronic device 102 according to the content provided by the image data and/or the position of the hand 1050 of the user 105. The external electronic device 102 may generate the visual object in a transparent layer 820 in response to the signal.

As described above, according to an embodiment, the electronic device 101 may, based on identifying the hand 1050 of the user 105, identify a visual object 1050 based on an augmented reality service (e.g., a game service, and/or a video streaming service). The electronic device 101 may indicate an interaction between the augmented reality service and the user 105 by projecting the visual object 1010 onto the hand 1050 of the user. The electronic device 101 may enhance, using the visual object 1050 projected onto the hand 1050 of the user 105, a user experience.

FIG. 11 illustrates an example of a flowchart indicating an operation of an electronic device according to an embodiment. At least some operations of FIG. 11 may be performed by the electronic device 101 of FIG. 2 and/or the processor 210-1 of FIG. 2. Each of the operations of FIG. 11 may be performed sequentially, but is not necessarily performed sequentially. For example, an order of each of the operations may be modified, and at least two operations may be performed in parallel.

Referring to FIG. 11, in operation 1110, according to an embodiment, the electronic device may identify, via communication circuitry, an external electronic device including another projection assembly distinct from a projection assembly. The electronic device may establish, using the communication circuitry (e.g., the communication circuitry 230-1 of FIG. 2), a communication link with the external electronic device (e.g., the external electronic device 102 of FIG. 2).

Referring to FIG. 11, according to an embodiment, in operation 1120, the electronic device may, in a state of displaying a screen based on a coupling of a first display area formed by the projection assembly and a second display area formed by the other projection assembly of the identified external electronic device, identify, using a camera, an external object that is spaced less than a specified distance from the electronic device. The electronic device may identify an external object (e.g., the user 105 of FIG. 1) spaced apart from the first display area (e.g., the first display area 410 of FIG. 4) and/or the second display area (e.g., the second display area 420 of FIG. 4) formed by the projection assembly (e.g., the projection assembly 240-1 of FIG. 2) of the electronic device.

Referring to FIG. 11, in operation 1130, according to an embodiment, the electronic device may, based on identifying the external object, control the projection assembly to move the first display area in a direction in which the second display area is formed to increase a size of an overlapping area in which the first display area and the second display area overlap. The electronic device may transmit a signal indicating to modify the second display area to the external electronic device to increase the size of the overlapping area (e.g., the overlapping area 430 of FIG. 4). The external electronic device may control, in response to the signal, the projection assembly (e.g., the projection assembly 240-2 of FIG. 2) to move the second display area in a direction in which the first display area is formed. For example, the electronic device may determine the size of the overlapping area based on identifying a size of media content (e.g., the media content 806 of FIG. 8) included in the screen.

Referring to FIG. 11, in operation 1140, according to an embodiment, the electronic device may, based on the motion of the external object, identify a point within the overlapping area formed by the moved first display area. The electronic device may identify, based on identifying the motion of the external object using the camera, a height (e.g., a height of an arm) and/or a position of the external object. The electronic device may identify the point (e.g., the point 160 in FIG. 5) within the overlapping area based on the motion.

Referring to FIG. 11, in operation 1150, according to an embodiment, the electronic device may generate a visual object to mask a portion of the first display area based on the identified point. For example, the electronic device may, based on identifying the point (e.g., the point 160 of FIG. 5), generate a visual object (e.g., the transparent layer 110 of FIG. 5) based on a shape of a first portion (e.g., the first portion 510 of FIG. 5) and/or a second portion (e.g., the second portion 520 of FIG. 5) of the screen. The electronic device may mask a portion of a screen to be displayed on the second portion by displaying the visual object overlapping the screen. The electronic device may transmit a signal requesting generating a second visual object (e.g., the transparent layer 120 of FIG. 5) corresponding to the first visual object, which is the visual object, to the external electronic device. The electronic device may prevent a shadow of the external object to be generated by the projection assembly by masking a portion of a screen to be projected onto the second portion as the first visual object.

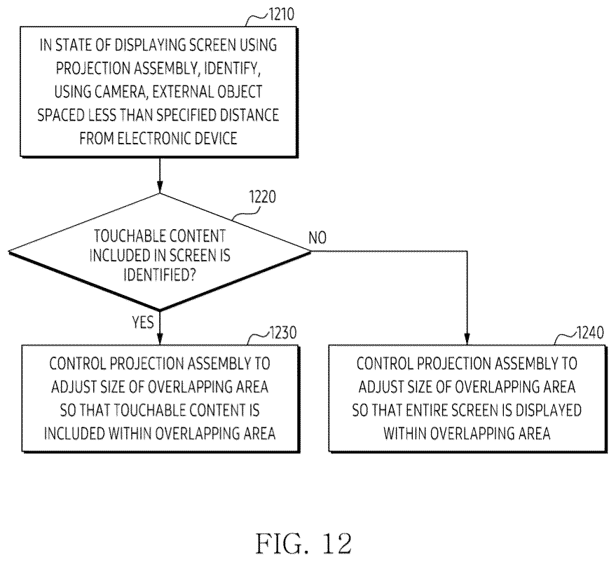

FIG. 12 illustrates an example flowchart indicating an electronic device according to an embodiment adjusting a size of an overlapping area. At least some operations of FIG. 12 may be performed by the electronic device 101 of FIG. 2 and/or the processor 210-1 of FIG. 2. Each of the operations of FIG. 12 may be performed sequentially, but is not necessarily performed sequentially. For example, an order of each of the operations may be modified, and at least two operations may be performed in parallel. At least some of the operations of FIG. 12 may be related to at least one of the operations of FIG. 11.

Referring to FIG. 12, in operation 1210, according to an embodiment, the electronic device may, in a state of displaying a screen using a projection assembly, identify an external object that is spaced less than a specified distance from the electronic device, using a camera,. An operation performed by the electronic device in the operation 1210 may be substantially similar to the operation performed in the operation 1110 and/or the operation 1120 of FIG. 11. Hereinafter, an overlapping description will be omitted.

Referring to FIG. 12, according to an embodiment, in operation 1220, the electronic device may check whether touchable content included in a screen has been identified. The electronic device may, based on obtaining the image data 805 of FIG. 8, identify media content (e.g., the media content 806 of FIG. 8) included in the image data.

Referring to FIG. 12, in a case that the touchable content is identified (the operation 1220—YES), in operation 1230, the electronic device according to an embodiment may control the projection assembly to adjust a size of an overlapping area so that the touchable content is included within the overlapping area. For example, a state in which the electronic device identifies the content may be referred to as the state 800 of FIG. 8. The electronic device may identify the size of the overlapping area corresponding to a size of the content. The electronic device may move a first display area (e.g., the first display area 410 of FIG. 8) in a direction in which a second display area (e.g., the second display area 420 of FIG. 8) is formed based on identifying the size of the overlapping area. The electronic device may, based on a position of the content within the overlapping area, obtain a transparent layer (e.g., the transparent layer 810 of FIG. 8). For example, the electronic device may update the transparent layer based on motion indicating hovering of a user (e.g., the user 105 of FIG. 1) to select the content. The electronic device may transmit a signal indicating generating another transparent layer (e.g., the transparent layer 820 of FIG. 8) corresponding to the transparent layer to the external electronic device.

Referring to FIG. 12, in a case that the touchable content is not identified (the operation 1220—NO), in operation 1240, the electronic device according to an embodiment may control the projection assembly to adjust the size of the overlapping area so that an entire screen is displayed within the overlapping area. A state in which the entire screen is included within the overlapping area may be referred to as the state 500 of FIG. 5. For example, the electronic device may control the projection assembly to adjust the first display area (e.g., the first display area 410 of FIG. 4) of the electronic device in the direction in which the second display area (e.g., the second display area of FIG. 4) is formed. For example, the electronic device may, based on motion (e.g., motion of raising an arm) of an external object (e.g., the user 105 of FIG. 1), predict a point (e.g., the point 160 of FIG. 5) within the overlapping area. The electronic device may, based on the predicted point, generate a transparent layer (e.g., the transparent layer 110 of FIG. 5). The electronic device may transmit a signal to the external electronic device requesting generating another transparent layer (e.g., the transparent layer 120 of FIG. 5) corresponding to the transparent layer. For example, the external electronic device may generate the other transparent layer in response to the signal.

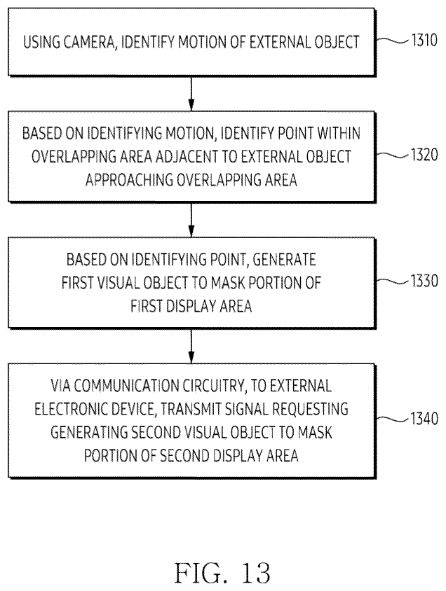

FIG. 13 illustrates an example of a flowchart indicating an operation of an electronic device according to an embodiment. At least some operations of FIG. 13 may be performed by the electronic device 101 of FIG. 2 and/or the processor 210-1 of FIG. 2. Each of the operations of FIG. 13 may be performed sequentially, but is not necessarily performed sequentially. For example, an order of each of the operations may be modified, and at least two operations may be performed in parallel. At least one of the operations of FIG. 13 may be related to at least one of the operations of FIG. 11 and/or the operations of FIG. 12.

Referring to FIG. 13, in operation 1310, according to an embodiment, the electronic device may identify, using a camera, motion of an external object. The electronic device may identify an external object that is spaced less than a specified distance from the electronic device, using a camera. The electronic device may adjust a size of an overlapping area (e.g., the overlapping area 430 of FIG. 4) based on identifying the external object. Motion of the external object may include motion of the user 105 of FIG. 1 raising an arm.

Referring to FIG. 13, in operation 1320, according to an embodiment, the electronic device may identify, based on identifying the motion, a point within the overlapping area adjacent to the external object approaching the overlapping area. Based on the motion of the user (e.g., the user 105 of FIG. 1), the electronic device may predict the point (e.g., the point 160 of FIG. 1) based on a height and/or a position of an arm of the user. The electronic device may distinguish a screen indicated by the image data 505 of FIG. 5 based on the point. For example, the electronic device may identify an input for a plurality of points (e.g., the points 660 of FIG. 6) within the overlapping area based on the motion of the user. For example, the electronic device may identify a point (e.g., the point 706 of FIG. 7) and a path 707 along which the point based on the motion of the user has moved within the overlapping area.

Referring to FIG. 13, in operation 1330, according to an embodiment, the electronic device may, based on identifying the point, generate a first visual object to mask a portion of a first display area. The first visual object may include at least one of the transparent layer 110 of FIG. 5, the transparent layer 610 of FIG. 6, and/or the transparent layer 710 of FIG. 7.

Referring to FIG. 13, in operation 1340, according to an embodiment, the electronic device may transmit, via communication circuitry, to the external electronic device, a signal requesting generating a second visual object to mask a portion of a second display area. The second visual object may include at least one of the transparent layer 120 of FIG. 5, the transparent layer 620 of FIG. 6, and/or the transparent layer 720 of FIG. 7. The signal may include the signal 312 of FIG. 3. For example, the electronic device may, based on identifying the plurality of points and/or the path along which the points have been moved, transmit a signal requesting an update of the second visual object to the external electronic device. The external electronic device may update the second visual object in response to the signal.

As described above, by updating the first visual object (e.g., a transparent layer) based on the motion of the user, the electronic device may prevent generating a shadow corresponding to the motion of the user by displaying the first visual object suitable for the motion of the user.

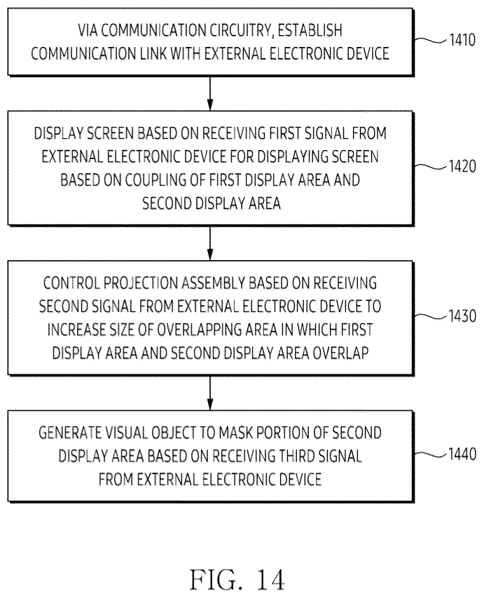

FIG. 14 illustrates an example of a flowchart indicating an operation of an electronic device according to an embodiment. At least some operations of FIG. 14 may be performed by the external electronic device 102 of FIG. 2 and/or the processor 210-2 of FIG. 2. Each of the operations of FIG. 14 may be performed sequentially, but is not necessarily performed sequentially. For example, an order of each of the operations may be modified, and at least two operations may be performed in parallel. The external electronic device of FIG. 14 may be referred to the electronic device 101 of FIG. 2.

Referring to FIG. 14, in operation 1410, according to an embodiment, an electronic device may establish, via communication circuitry, a communication link with an external electronic device. For example, the electronic device may establish the communication link with the external electronic device (e.g., the electronic device 101 of FIG. 2) using the communication circuitry 230-2 of FIG. 2.

Referring to FIG. 14, in operation 1420, according to an embodiment, the electronic device may display a screen based on receiving a first signal for displaying a screen based on a coupling of a first display area and a second display area from the external electronic device. The external electronic device may control a projection assembly (e.g., the projection assembly 240-1 of FIG. 2) to display a portion of the screen in the first display area (e.g., the first display area 410 of FIG. 4) based on transmitting the first signal. The electronic device may display, in response to the first signal, another portion of the screen in the second display area (e.g., the second display area 420 of FIG. 4). At least a portion of the first display area and at least a portion of the second display area may overlap.

Referring to FIG. 14, in operation 1430, according to an embodiment, the electronic device may, based on receiving a second signal from the external electronic device to increase a size of an overlapping area in which the first display area and the second display area overlap, control the projection assembly. The external electronic device may transmit the second signal (e.g., the signal 307 of FIG. 3) to the electronic device based on identifying an external object using a camera (e.g., the camera 250-1 of FIG. 2) of the external electronic device. The electronic device may control the projection assembly (e.g., the projection assembly 240-2 of FIG. 2) in response to the second signal to adjust the second display area in a direction in which the first display area is formed.

Referring to FIG. 14, in operation 1440, according to an embodiment, the electronic device may, based on receiving a third signal from the external electronic device, generate a visual object to mask a portion of the second display area. The external electronic device may identify motion of the external object using the camera. The external electronic device may identify a point (e.g., the point 160 of FIG. 1) adjacent to the external object within the overlapping area based on identifying the motion of the external object. The external electronic device may generate a visual object (e.g., the transparent layer 110 of FIG. 1) corresponding to the point. The external electronic device may transmit the third signal (e.g., the signal 312 of FIG. 3) requesting generating a visual object (e.g., the transparent layer 120 of FIG. 1) corresponding to the visual object to the electronic device. The electronic device may generate a visual object (e.g., the transparent layer 120 of FIG. 1) to mask a portion (e.g., the first portion 510 of FIG. 5) of the second display area in response to the third signal. The electronic device may block the screen from being displayed on the portion (e.g., the first portion 510 of FIG. 5) of the second display area by projecting the visual object (e.g., the transparent layer 120 of FIG. 1) overlapping the screen onto the second display area.

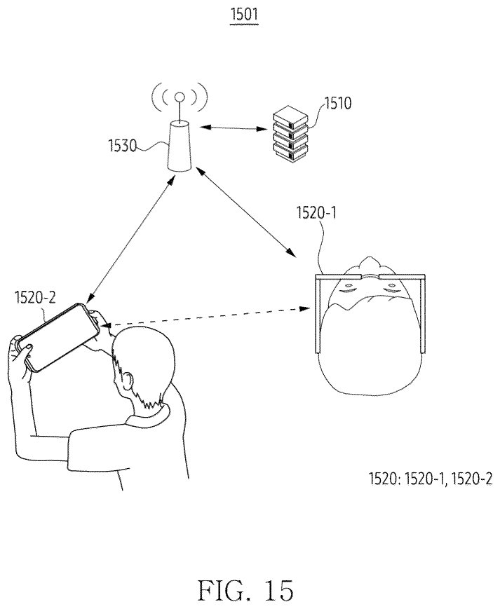

FIG. 15 is an example diagram of a network environment related to a metaverse service. Metaverse is a compound word of the English words “Meta” meaning “virtual” and “transcendence” and “Universe” meaning cosmos, and refers to a three-dimensional virtual world in which social, economic, and cultural activities take place like a real world. Metaverse is a concept that has evolved one step further than a virtual reality (VR, cutting-edge technology that enables people to experience real-life experiences in a virtual world created by a computer), and Metaverse is characterized by using avatars to enjoy games or virtual reality (social and cultural activities like a reality). A metaverse service may provide media content for enhancing immersion in the virtual world, based on an augmented reality (AR), a virtual reality environment (VR), a mixed environment (MR), and/or an extended reality (XR).

For example, media content provided by the metaverse service may include social interaction content including avatar-based game, concert, party, and/or meeting. For example, the media content may include information for economic activities such as advertising, user created content, and/or sales and/or shopping of productions. Ownership of the user created content may be proved by a blockchain-based Non-Fungible Token (NFT). The metaverse service may support economic activities based on real money and/or cryptocurrency. By the metaverse service, virtual content associated with the real world, such as digital twin or life logging, may be provided.

FIG. 15 is an example diagram of a network environment 1501 in which a metaverse service is provided through a server 1510.

Referring to FIG. 15, a network environment 1501 may include a server 1510, a user terminal 1520 (e.g., a first terminal 1520-1 and a second terminal 1520-2), and a network connecting the server 1510 and the user terminal 1520. In the network environment 1501, the server 1510 may provide a metaverse service to the user terminal 1520. The network may be formed by at least one intermediate node 1530 including an access point (AP) and/or a base station. The user terminal 1520 may access the server 1510 through the network and output a user interface (UI) associated with a metaverse service to a user of the user terminal 1520. Based on the UI, the user terminal 1520 may obtain information to be inputted into the metaverse service from the user, or output information (e.g., multimedia content) associated with the metaverse service to the user.

In this case, the server 1510 provides a virtual space so that the user terminal 1520 may perform activities in the virtual space. In addition, the user terminal 1520 may represent information provided by the server 1510 to the user by installing an S/W agent to access the virtual space provided by the server 1510, or transmit information that the user wants to represent in the virtual space to the server. The S/W agent may be provided directly through the server 1510, downloaded from a public server, or embedded and provided when purchasing a terminal.

In an embodiment, the metaverse service may provide a service to the user terminal 1520 and/or a user by using the server 1510. The disclosure is not limited to the above example embodiment. The metaverse service may be provided through individual contacts between users. For example, in the network environment 1501, the metaverse service may be provided by a direct connection between the first terminal 1520-1 and the second terminal 1520-2, independently of the server 1510. Referring to FIG. 15, in the network environment 1501, the first terminal 1520-1 and the second terminal 1520-2 may be connected to each other through a network formed by at least one intermediate node 1530. In an embodiment in which the first terminal 1520-1 and the second terminal 1520-2 are directly connected, any one of the first terminal 1520-1 and the second terminal 1520-2 may perform a role of the server 1510. For example, a metaverse environment may be configured only with a device-to-device connection (e.g., a peer-to-peer (P2P) connection).

In an embodiment, the user terminal 1520 (or the user terminal 1520 including the first terminal 1520-1 and the second terminal 1520-2) may be made in various form factors, and it is characterized by including an output device for providing an image and/or sound to the user and an input device for inputting information into the metaverse service. An example user terminal 1520 in various form factors may include a smartphone (e.g., the second terminal 1520-2), an AR device (e.g., the first terminal 1520-1), a VR device, an MR device, a Video-See-Through (VST) device, an Optical-See-Through (OST) device, a smart lens, a smart mirror, a TV capable of inputting and outputting, or a projector.

A network (e.g., a network formed by at least one intermediate node 1530) includes all of various broadband networks including 3G, 4G, and 5G and short-range networks (e.g., a wired network or a wireless network that directly connects the first terminal 1520-1 and the second terminal 1520-2) including Wi-Fi and BT.

For example, the user terminal 1520 may include the electronic device 101 of FIGS. 1 to 14.

According to an embodiment, the electronic device may control a projection assembly based on motion of a user obtained using a camera to remove a shadow to be generated by light being projected. A method for the electronic device to remove the shadow using a transparent layer corresponding to the motion of the user may be required.

As described above, an electronic device 101 according to an embodiment may comprise communication circuitry 230-1, a camera 250-1, a projection assembly 240-1, and one or more processors 210-1. The one or more processors may identify, via the communication circuitry, an external electronic device 102 including another projection assembly 240-2 distinct from the projection assembly. The one or more processors may, based on identifying the external electronic device, transmit, to the external electronic device, a first signal 305 for displaying a screen based on a combination of a first display area 410 formed by the projection assembly and a second display area 420 formed by the another projection assembly. The one or more processors may, based on identifying, using the camera, an external object 105 spaced less than a specified distance from the first display area and the second display area, transmit, to the external electronic device, a second signal 307 to increase a size of an overlapping area 430 in which the first display area and the second display area overlap. The one or more processors may, based on identifying motion of the external object related to the overlapping area with the increased size based on the second signal, display, using the projection assembly, a visual object 110, 610, 710, or 810 with a shape related to the motion within the first display area, superimposed on the screen projected onto the first display area by the projection assembly.

For example, the one or more processors may identify, based on identifying the motion, a point 160, 660, or 706 within the overlapping area adjacent to the external object approaching the overlapping area by the motion. The one or more processors may display, among portions 510 and 520 of the first display area distinguished by the point, the visual object in a second portion 520 different from a first portion 510 adjacent to the projection assembly.

For example, the one or more processors may, based on identifying the point, display the visual object to mask the second portion among the first portion and the second portion. The one or more processors may transmit, to the external electronic device, a third signal requesting generating a second visual object 120, 620, 720, or 820 different from a first visual object, which is the visual object.

For example, the one or more processors may transmit, to the external electronic device, the third signal 312 to request generating the second visual object to mask a portion adjacent to the projection assembly among portions of the second display area distinguished by the point.

For example, the one or more processors may identify, using the camera, movement of the point. The one or more processors may modify the visual object based on a path 707 along which the point has been moved.

For example, the one or more processors may identify, using the camera, at least one illuminant 912. The one or more processors may generate a third visual object 910 with a shape of a shadow generated by light projected from the at least one illuminant onto the external object.

For example, the one or more processors may identify, using the camera, a position of the external object. The one or more processors may, based on the identified position of the external object, generate a fourth visual object 1010 to be displayed on the external object.

For example, the one or more processors may identify one or more media contents 806 included in the screen. The one or more processors may, based on positions of the one or more media contents, generate the visual object.

As described above, a method for an electronic device according to an embodiment may comprise identifying, via communication circuitry, an external electronic device including another projection assembly distinct from a projection assembly. The method may comprise, based on identifying the external electronic device, transmitting to the external electronic device, a first signal for displaying a screen based on a combination of a first display area formed by the projection assembly and a second display area formed by the another projection assembly. The method may comprise, based on identifying, using the camera, an external object that is spaced less than a specified distance from the first display area and the second display area, transmitting, to the external electronic device, a second signal to increase a size of an overlapping area in which the first display area and the second display area overlap. The method may comprise, based on identifying motion related to the overlapping area with the increased size based on the second signal, displaying, using the projection assembly, a visual object with a shape related to the motion within the first display area, superimposed on the screen projected onto the first display area by the projection assembly.

For example, the displaying the visual object may comprise identifying, based on identifying the motion, a point within the overlapping area adjacent to the external object approaching the overlapping area by the motion. The displaying the visual object may comprise displaying among portions of the first display area distinguished by the point, the visual object in a second portion different from a first portion adjacent to the projection assembly.

For example, the identifying the point may comprise, based on identifying the point, displaying the visual object to mask the second portion among the first portion and the second portion. The identifying the point may comprise transmitting, to the external electronic device, a third signal requesting generating a second visual object different from a first visual object, which is the visual object.

For example, the transmitting the third signal may comprise transmitting, to the external electronic device, the third signal to request generating the second visual object to mask a portion adjacent to the projection assembly among portions of the second display area distinguished by the point.

For example, the identifying the point may comprise identifying, using the camera, movement of the point. The identifying the point may comprise modifying the visual object based on a path along which the point has been moved.

For example, the displaying the visual object may comprise identifying, using the camera, at least one illuminant. The displaying the visual object may comprise generating a third visual object with a shape of a shadow generated by light projected from the at least one illuminant onto the external object.

For example, the displaying the visual object may comprise identifying, using the camera, a position of the external object. The displaying the visual object may comprise, based on the identified position of the external object, generate a fourth visual object to be displayed on the external object.

For example, the displaying the visual object may comprise identifying one or more media contents included in the screen. The displaying the visual object may comprise, based on positions of the one or more media contents, generating the visual object.

As described above, an electronic device 101 according to an embodiment may comprise communication circuitry 230-1, a camera 250-1, a projection assembly 240-1, and one or more processors 210-1. The one or more processors may identify, via the communication circuitry, an external electronic device 102 including another projection assembly 240-2 distinct from the projection assembly. The one or more processors may, in a state of displaying a screen based on a combination of a first display area 410 formed by the projection assembly and a second display area 420 formed by the another projection assembly of the identified external electronic device, identify, using the camera, an external object 105 spaced less than a specified distance from the electronic device. The one or more processors may, based on identifying the external object, control the projection assembly to move the first display area in a direction in which the second display area is formed to increase a size of an overlapping area 430 in which the first display area and the second display area overlap. The one or more processors may identify, based on motion of the external object, a point 160, 660, or 706 within the overlapping area formed by the moved first display area. The one or more processors may be configured to generate a visual object 110, 610, 710, or 810 to mask a portion of the first display area based on the identified point.

For example, the one or more processors may be configured to display the visual object superimposed on the screen projected onto the first display area by the projection assembly.

For example, the one or more processors may be configured to display, among portions of the first display area distinguished by the point, the visual object in a second portion 520 of the first display area different from a first portion 510 adjacent to the projection assembly.

For example, the one more processors may identify, using the camera, a second point 660-2 different from a first point 660-1, which is the point, based on motion of the external object. The one or more processors may be configured to modify the visual object corresponding to the first point and the second point.

A method for an electronic device according to an embodiment as described above, the method may comprise identifying, via communication circuitry, an external electronic device including another projection assembly distinct from a projection assembly of the electronic device. The method may comprise, in a state of displaying a screen based on a combination of a first display area formed by the projection assembly and a second display area formed by the another projection assembly of the identified external electronic device, identifying, using a camera, an external object that is spaced less than a specified distance from the electronic device. The method may, based on identifying the external object, control the projection assembly to move the first display area in a direction in which the second display area is formed to increase a size of an overlapping area in which the first display area and the second display area overlap. The method may comprise identifying, based on motion of the external object, a point within the overlapping area formed by the moved first display area. The method may comprise generating a visual object to mask a portion of the first display area based on the identified point.

For example, the generating the visual object may comprise displaying the visual object superimposed on the screen projected onto the first display area by the projection assembly.

For example, the generating the visual object may comprise displaying, among portions of the first display area distinguished by the point, the visual object in a second portion of the first display area different from a first portion adjacent to the projection assembly.

For example, the generating the visual object may comprise identifying, using the camera, a second point different from a first point, which is the point, based on motion of the external object. The generating the visual object may comprise modifying the visual object corresponding to the first point and the second point.

The device described above may be implemented as a hardware component, a software component, and/or a combination of a hardware component and a software component. For example, the devices and components described in the embodiments may be implemented by using one or more general purpose computers or special purpose computers, such as a processor, controller, ALU, digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device comprising:
communication circuitry;
a camera;
a first projection assembly;
at least one processor comprising processing circuitry, the at least one processor being operatively connected with the communication circuitry, the camera, and the first projection assembly; and
memory comprising one or more storage mediums storing instructions,
wherein the instructions, when executed by the at least one processor individually or collectively, cause the electronic device to:
identify, via the communication circuitry, an external electronic device including a second projection assembly distinct from the first projection assembly,
based on identifying the external electronic device, transmit, to the external electronic device, a first signal for displaying a screen based on a combination of a first display area formed by the first projection assembly and a second display area formed by the second projection assembly,
based on identifying, using the camera, an external object that is spaced less than a specified distance from the first display area and the second display area, transmit, to the external electronic device, a second signal to increase a size of an overlapping area in which the first display area and the second display area overlap, and
based on identifying a motion of the external object related to the overlapping area with the increased size increased based on the second signal, display, using the first projection assembly, a visual object with a shape related to the motion within the first display area, the visual object being superimposed on the screen projected onto the first display area by the first projection assembly.

2. The electronic device of claim 1, wherein the instructions, when executed by the at least one processor individually or collectively, further cause the electronic device to:
identify, based on identifying the motion, a point within the overlapping area adjacent to the external object approaching the overlapping area by the motion, and
display, among portions of the first display area distinguished by the point, the visual object in a second portion different from a first portion adjacent to the first projection assembly.

3. The electronic device of claim 2, wherein the instructions, when executed by the at least one processor individually or collectively, further cause the electronic device to:
based on identifying the point, display the visual object that masks the second portion among the first portion and the second portion, and
transmit, to the external electronic device, a third signal requesting generating a second visual object different from a first visual object, the second visual object being the visual object.

4. The electronic device of claim 3, wherein the instructions, when executed by the at least one processor individually or collectively, further cause the electronic device to transmit, to the external electronic device, the third signal to request generating the second visual object that masks a portion adjacent to the first projection assembly among portions of the second display area distinguished by the point.

5. The electronic device of claim 2, wherein the instructions, when executed by the at least one processor individually or collectively, further cause the electronic device to:
identify, using the camera, a movement of the point; and
modify the visual object based on a path along which the point is moved.

6. The electronic device of claim 1, wherein the instructions, when executed by the at least one processor individually or collectively, further cause the electronic device to:
identify, using the camera, at least one illuminant; and
generate a third visual object with a shape of a shadow generated by light projected from the at least one illuminant onto the external object.

7. The electronic device of claim 1, wherein the instructions, when executed by the at least one processor individually or collectively, further cause the electronic device to:
identify, using the camera, a position of the external object; and
based on the identified position of the external object, generate a fourth visual object to be displayed on the external object.

8. The electronic device of claim 1, wherein the instructions, when executed by the at least one processor individually or collectively, further cause the electronic device to:
identify one or more media contents included in the screen; and
based on positions of the one or more media contents, generate the visual object.

9. A method for an electronic device comprising a first projection assembly, the method comprising:
identifying, via communication circuitry, an external electronic device including a second projection assembly distinct from the first projection assembly;
based on identifying the external electronic device, transmitting to the external electronic device, a first signal for displaying a screen based on a combination of a first display area formed by the first projection assembly and a second display area formed by the second projection assembly;
based on identifying, using a camera, an external object that is spaced less than a specified distance from the first display area and the second display area, transmitting, to the external electronic device, a second signal to increase a size of an overlapping area in which the first display area and the second display area overlap; and
based on identifying motion of the external object related to the overlapping area with the increased size increased based on the second signal, displaying, using the first projection assembly, a visual object with a shape related to the motion within the first display area, the visual object being superimposed on the screen projected onto the first display area by the first projection assembly.

10. The method of claim 9, wherein the displaying the visual object comprises:
identifying, based on identifying the motion, a point within the overlapping area adjacent to the external object approaching the overlapping area by the motion; and
displaying among portions of the first display area distinguished by the point, the visual object in a second portion different from a first portion adjacent to the first projection assembly.

11. The method of claim 10, wherein the identifying the point comprises:
based on identifying the point, displaying the visual object that masks the second portion among the first portion and the second portion, and
transmitting, to the external electronic device, a third signal requesting generating a second visual object different from a first visual object, the second visual object being the visual object.

12. The method of claim 11, wherein the transmitting the third signal comprises transmitting, to the external electronic device, the third signal to request generating the second visual object that masks a portion adjacent to the first projection assembly among portions of the second display area distinguished by the point.

13. The method of claim 10, wherein the identifying the point comprises:
identifying, using the camera, a movement of the point; and
modifying the visual object based on a path along which the point is moved.

14. The method of claim 9, wherein the displaying the visual object comprises:
identifying, using the camera, at least one illuminant; and
generating a third visual object with a shape of a shadow generated by light projected from the at least one illuminant onto the external object.

15. The method of claim 9, wherein the displaying the visual object comprises:
identifying, using the camera, a position of the external object; and
based on the identified position of the external object, generating a fourth visual object to be displayed on the external object.

16. The method of claim 9, wherein the displaying the visual object comprises:
identifying one or more media contents included in the screen; and
based on positions of the one or more media contents, generating the visual object.

17. An electronic device comprising:
communication circuitry;
a camera;
a first projection assembly;
at least one processor comprising processing circuitry, the at least one processor being operatively connected with the with the communication circuitry, the camera, and the first projection assembly; and
memory comprising one or more storage mediums storing instructions,
wherein the instructions, when executed by the at least one processor individually or collectively, cause the electronic device to:
identify, via the communication circuitry, an external electronic device including a second projection assembly distinct from the first projection assembly;
in a state of displaying a screen based on a combination of a first display area formed by the first projection assembly and a second display area formed by the second projection assembly of the identified external electronic device, identify, using the camera, an external object that is spaced less than a specified distance from the electronic device;
based on identifying the external object, control the first projection assembly to move the first display area in a direction in which the second display area is formed to increase a size of an overlapping area in which the first display area and the second display area overlap;
identify, based on a motion of the external object, a point within the overlapping area formed by the moved first display area; and
generate a visual object that masks a portion of the first display area based on the identified point.

18. The electronic device of claim 17, wherein the instructions, when executed by the at least one processor individually or collectively, further cause the electronic device to display the visual object superimposed on the screen projected onto the first display area by the first projection assembly.

19. The electronic device of claim 17, wherein the instructions, when executed by the at least one processor individually or collectively, further cause the electronic device to display, among portions of the first display area distinguished by the point, the visual object in a second portion of the first display area different from a first portion adjacent to the first projection assembly.

20. The electronic device of claim 17, wherein the instructions, when executed by the at least one processor individually or collectively, further cause the electronic device to:
identify, using the camera, a second point different from a first point, the second point being the point, based on the motion of the external object; and
modify the visual object corresponding to the first point and the second point.
